(19) United States
(12) Patent Application Publication
(10) Pub. No.: US 2023/0373142 A1
(43) Pub. Date: Nov. 23, 2023

(54) Electro Fluid Driven Actuator and Method

(71) Applicant: Barnes Group, Inc., Bristol, CT (US)

(72) Inventor: Vito Galati, Rowley, MA (US)

(21) Appl. No.: 18/229,307

(22) Filed: Aug. 2, 2023

Related U.S. Application Data
(63) Continuation of application No. PCT/US22/43567, filed on Sep. 15, 2022.
(60) Provisional application No. 63/244,579, filed on Sep. 15, 2021.

(51) Int. Cl. B29C 45/28; B29C 45/27; B29C 45/76

(52) U.S. Cl. CPC B29C 45/281; B29C 45/2725; B29C 45/762; B29C 2045/2848; B29C 2945/76006; B29C 2945/76083; B29C 2945/762; B29C 2945/76204; B29C 2945/76859; B29C 2945/76598; B29C 2945/76568; B29C 2945/7612

(57) ABSTRACT

An injection molding apparatus (5), comprising:
a first fluid drive cylinder (940c, 941c, 942c),
a second fluid drive cylinder (940ac, 941ac, 942ac) interconnected to a valve pin (1040, 1041, 1042),
wherein the first fluid drive cylinder (940c, 941c, 942c) and the second fluid drive cylinder (940ac, 941ac, 942ac) are interconnected in an arrangement wherein reciprocating movement of a piston (940p, 941p, 942p) of the first cylinder drives concomitant back and forth movement of a piston (940ap, 941ap, 942ap) of the second cylinder and concomitant back and forth movement of the valve pin (1040, 1041, 1042);
an electrically powered actuator (940, 941, 942) adapted to drive the piston of the first cylinder reciprocally according to a drive program such that the valve pin (1040, 1041, 1042) is driven between gate closed and gate open positions and selected positions therebetween.

### RELATED APPLICATIONS

The disclosures of all of the following are incorporated by reference in their entirety as if fully set forth herein: U.S. Pat. Nos. 5,894,025, 6,062,840, 6,294,122 (7018), U.S. Pat. Nos. 6,309,208, 6,287,107, 6,343,921, 6,343,922, 6,254,377, 6,261,075, 6,361,300 (7006), U.S. Pat. Nos. 6,419,870, 6,464,909 (7031), U.S. Pat. No. 6,062,840 (7052), U.S. Pat. No. 6,261,075 (7052US1), U.S. Pat. Nos. 6,599,116, 7,234,929 (7075US1), U.S. Pat. No. 7,419,625 (7075US2), U.S. Pat. No. 7,569,169 (7075US3), U.S. Pat. No. 8,297,836 (7087) U.S. patent application Ser. No. 10/214,118, filed Aug. 8, 2002 (7006), U.S. Pat. No. 7,029,268 (7077US1), U.S. Pat. No. 7,270,537 (7077US2), U.S. Pat. No. 7,597,828 (7077US3), U.S. patent application Ser. No. 09/699,856 filed Oct. 30, 2000 (7056), U.S. patent application Ser. No. 10/269,927 filed Oct. 11, 2002 (7031), U.S. application Ser. No. 09/503,832 filed Feb. 15, 2000 (7053), U.S. application Ser. No. 09/656,846 filed Sep. 7, 2000 (7060), U.S. application Ser. No. 10/006,504 filed Dec. 3, 2001, (7068), International Application WO2011119791 filed Mar. 24, 2011 (7094), U.S. application Ser. No. 10/101,278 filed Mar. 19, 2002 (7070) and PCT Application No. PCT/US11/062099 (7100WO0) and PCT Application No. PCT/US11/062096 (7100W01), U.S. Pat. Nos. 8,562,336, 8,091,202 (7097US1) and U.S. Pat. No. 8,282,388 (7097US2), U.S. Pat. No. 9,205,587 (7117US0), U.S. application Ser. No. 15/432,175 (7117US2) filed Feb. 14, 2017, U.S. Pat. No. 9,144,929 (7118U50), U.S. Publication No. 20170341283 (7118US3), U.S. Pat. No. 9,724,861 (7129US4), U.S. Pat. No. 9,662,820 (7129US3), international application WO2014172100 (7131WO0), Publication No. WO2014209857 (7134WO0), international application WO2015066004 (7140WO0), Publication No. WO2015006261 (7135WO0), International application Publication No. WO2016153632 (7149W02), International application publication no. WO2016153704 (7149WO4), U.S. Pat. No. 9,937,648 (7135US2), U.S. patent Ser. No. 10/569,458 (7162US1), International Application WO2017214387 (7163WO0), International Application PCT/US17/043029 (7165WO0) filed Jul. 20, 2017, International Application PCT/US17/043100 (7165WO1), filed Jul. 20, 2017 and International Application PCT/US17/036542 (7163WO0) filed Jun. 8, 2017 and International Application WO2018129015 (7169WO0), International application WO2018148407 (7170WO0), International application WO2018148407 (7171WO0), international application WO2018175362 (7172WO0), international application WO2018194961 (7174WO0), international application WO2018200660 (7176WO0), international application WO2019013868 (7177WO0), international application WO2019100085 (7178WO0), international application WO2020176479 (7185WO0), international application WO2021/034793 (7187WO0), international application WO2021080767 (7188WO0).

### BACKGROUND OF THE INVENTION

Injection molding systems have been developed for performing injection molding cycles controlled by an electric motor actuator the rotary drive component of which is interconnected directly to a valve pin via a rotary to linear travel converter device that drives the valve pin along a linear path of travel between gate closed and one or more gate open positions.

### SUMMARY OF THE INVENTION

In accordance with the invention there is provided an injection molding apparatus (5), comprising:
an injection molding machine (13) adapted to inject a flow of injection fluid (18) to a heated manifold (40), the heated manifold adapted to distribute the injection fluid (18) to a flow channel (20f, 22f, 240 that is adapted to deliver the injection fluid to a gate (32, 34, 36) of a mold cavity (30);
a first fluid drive cylinder (940c, 941c, 942c) having a first piston (940p, 941p, 942p) disposed within the first fluid drive cylinder (940c, 941c, 942c) adapted to be driven reciprocally upstream and downstream within the first fluid drive cylinder (940c, 941c, 942c);
a second fluid drive cylinder (940ac, 941ac, 942ac) having a second piston (940ap, 941ap, 942ap) disposed within the second fluid drive cylinder (940ac, 941ac, 942ac) and interconnected to a valve pin (1040, 1041, 1042)
wherein the first fluid drive cylinder (940c, 941c, 942c) and the second fluid drive cylinder (940ac, 941ac, 942ac) are interconnected in an arrangement wherein reciprocating movement of the first piston (940p, 941p, 942p) drives concomitant back and forth movement of the second piston (940ap, 941ap, 942ap) and concomitant back and forth movement of the valve pin along a selected path of travel (Y) within the flow channel (20f, 22f, 240 between gate closed and gate open positions;
an electrically powered actuator (940, 941, 942) adapted to drive the first piston (940p, 941p, 942p) reciprocally within the first fluid drive cylinder (940c, 941c, 942c) according to a drive program that instructs the electrically powered actuator to controllably drive the valve pin (1040, 1041, 1042) between the gate closed and gate open positions and one or more selected positions therebetween.

In such an apparatus the electrically powered actuator (940, 941, 942) exerts drive force on and drives movement of the first piston (940p, 941p, 942p) which in turn drives the second piston which in turn drives the valve pin (1040, 1041, 1042).

In such an apparatus, the electrically powered actuator (940, 941, 942) is typically the sole source of drive force on the first piston (940p, 941p, 942p). The electrically powered actuator is mechanically interconnected to the first piston and exerts drive force on the first piston via such mechanical interconnection

In such an apparatus the first fluid drive cylinder (940c, 941c, 942c) and the second fluid drive cylinder (940ac, 941ac, 942ac) are typically drivably interconnected in a closed fluid circuit arrangement.

In such an apparatus the electrically powered actuator (940, 941, 942) is typically mounted in a position remote from the heated manifold (40).

In such an apparatus the electrically powered actuator is typically mounted such that the electrically powered actuator is isolated from substantial communication of heat with the heated manifold (40).

In such an apparatus the first fluid drive cylinder (940c, 941c, 942c) and the second fluid drive cylinder (940ac, 941ac, 942ac) are typically interconnected via fluid sealed conduit (500, 600) that enables drive fluid to flow directly between the first fluid drive cylinder (940c, 941c, 942c) and the second fluid drive cylinder (940ac, 941ac, 942ac), the fluid sealed conduit including one or more connectors (700) adapted to enable the conduit interconnection (500, 600) between the first fluid drive cylinder (940c, 941c, 942c) and the second fluid drive cylinder (940ac, 941ac, 942ac) to be readily disconnected and readily connected.

In such an apparatus the electrically powered actuator can comprise either a linear actuator (940) or a rotatable actuator (940) having a driver (940ls, 940ld) arranged to drive the first piston (940p, 941p, 942p) reciprocally upstream and downstream within the first fluid drive cylinder (940c, 941c, 942c).

In such an apparatus the electrically powered actuator can comprise a linear travel converter (940l) adapted to drive the first piston (940p, 941p, 942p) along a selected linear converter path of travel (XX) that is non-coaxial with an axis (X) of the driver (940ls, 940ld).

Such an apparatus can further comprise a controller (16) and one or more of:
(i) a pressure sensor (800) adapted to sense pressure of drive fluid (DF) disposed within a fluid drive cylinder (940c, 941c, 942c, 940ac, 941ac, 942ac) and generate a signal indicative of the pressure of the drive fluid (DF),
(ii) a position sensor (900) adapted to sense axial position of the second piston (940ap, 941ap, 942ap) or the valve pin (1040, 1041, 1042) and generate a signal indicative of axial position of the second piston or the valve pin,
(iii) a position sensor (950) adapted to sense one or more of axial position of a piston, rotational position and velocity of a rotor (940r) of the electrically powered actuator (940, 941, 942) and generate a signal indicative of one or the other or both of rotational position and velocity of the rotor (940r),
(iv) a sensor (950) adapted to sense one or the other or both torque exerted by or current used by the electrically powered actuator (940, 941, 942) and generate a signal indicative of one or the other or both of torque and current, the controller (16) including an algorithm that utilizes one or more signals generated by the pressure sensor (800), the position sensor (900, 950) or the torque or current sensor (950) as a variable to controllably drive the second piston (940ap, 941ap, 942ap) and the valve pin (1040, 1041, 1042):
(a) to one or more predetermined axial positions during the course of an injection cycle, or,
(b) at one or more upstream or downstream velocities during the course of an injection cycle, or,
(c) to follow or match a preselected profile of pin positions or pin velocities during the course of an injection cycle, or,
(d) to open or close the gate or to trigger a movement or change in movement at a selected sensed pressure,
(e) to trigger an alarm indicative of degree of deviation in pressure of the drive fluid (DF) from one or more preselected desired pressures,
(f) upstream beginning from the gate closed position to a selected second intermediate upstream position at a first velocity, upstream from the second intermediate upstream position to a fully gate open position at one or more second velocities that are higher than the first velocity.

Such an apparatus can further comprise a signal converter (1500) for converting signals generated by an injection molding machine (IMM) having a drivably rotatable barrel screw (BS) that generates an injection fluid (18), wherein the injection molding machine (IMM) includes a machine controller (MC) or a control unit (HPU) that generates one or more directional control valve compatible signals (VPS), wherein the direction control valve compatible signals (VPS) are compatible for use by a signal receptor, interface or driver of a standard fluid directional control valve (12) to instruct the fluid directional control valve (12) to move to a position that routes a source of drive fluid to flow in a direction that drives an interconnected fluid drivable actuator (940f, 941f, 9420 to move in a direction that operates to begin an injection cycle and to move in a direction that operates to end an injection cycle,
wherein the signal converter (1500) is interconnected to the machine controller (MC) or control unit (HPU), the signal converter (1500) receiving and converting the directional control valve compatible signals (VPS) to a command signal (MOPCS, PDCVS) that is compatible with a signal receptor or interface of an electrically powered actuator (940e, 941e, 942e) or a signal receptor or interface of a proportional directional control valve (V, V1, V2) that drives a fluid driven actuator (940p, 941p, 942p),
wherein the signal converter (1500) includes a processor that converts the command signals (MOPCS, PDCVS) into a form, frequency, power or format that is usable by the signal receptor or interface of the electrically powered actuator (940e, 941e, 942e) or by the signal receptor or interface of the proportional directional control valve (V, V1, V2) to respectively cause the electrically powered actuator (940e, 941e, 942e) or the proportional directional control valve (V, V1, V2) to be driven in a direction that operates to either begin an injection cycle or to end an injection cycle.

In another aspect of the invention there is provided an injection molding method, comprising:
providing a valve pin (1040, 1041, 1042) that is disposed in a flow channel (20f, 22f, 240, the flow channel adapted to pass injection fluid (18) though a gate (32, 34, 36) and into a mold cavity (30);
providing a first fluid drive cylinder (940c, 941c, 942c) having a first piston (940p, 941p, 942p) that is interconnected to a second fluid drive cylinder (940ac, 941ac, 942ac) having a second piston (940ap, 941ap, 942ap) in an arrangement wherein reciprocating movement of the first piston (940p, 941p, 942p) drives concomitant back and forth movement of the second piston (940ap, 941ap, 942ap),
interconnecting the valve pin (1040, 1041, 1042) to the second piston (940ap, 941ap, 942ap) in an arrangement wherein reciprocating movement of the second piston drives concomitant back and forth movement of the valve pin (1040, 1041, 1042) through the flow channel (20f, 22f, 240 between gate open and gate closed positions,
providing an electrically powered actuator (940, 941, 942) that is interconnected to the first piston (940p, 941p, 942p);
injecting a flow of the injection fluid (18) to a heated manifold (40);
distributing the injection fluid, via the heated manifold, to the flow channel (20f, 22f, 240;
driving the first piston (940p, 941p, 942p) reciprocally within the first fluid drive cylinder (940c, 941c, 942c) via the electrically powered actuator (940, 941, 942) according to a drive program that instructs the valve pin (1040, 1041, 1042) to be driven between the gate closed and gate open positions and one or more selected positions therebetween.

Such a method typically further comprises using the electrically powered actuator (940, 941, 942) as the sole source of drive force on the first piston (940p, 941p, 942p).

Such a method typically further comprises drivably interconnecting the first fluid drive cylinder (940c, 941c, 942c) and the second fluid drive cylinder (940ac, 941ac, 942ac) in a closed fluid circuit arrangement.

Such a method typically further comprises disposing the electrically powered actuator in a position remote from the heated manifold.

Such a method typically further comprises sensing one or more of:
(i) pressure of drive fluid (DF) disposed within a fluid drive cylinder (940c, 941c, 942c, 940ac, 941ac, 942ac),
(ii) axial position of the second piston (940ap, 941ap, 942ap) or the valve pin (1040, 1041, 1042),
(iii) one or the other or both rotational position and velocity of a rotor (940r) of the electrically powered actuator (940, 941, 942),
(iv) one or the other or both torque exerted by or current used by the electrically powered actuator (940, 941, 942) and generate a signal indicative of one or the other or both of torque and current, and, using the sensed pressure, the sensed position, the sensed torque or current as a variable in an algorithm that controllably drives the second piston (940ap, 941ap, 942ap) and the valve pin (1040, 1041, 1042):
(a) to one or more predetermined axial positions during the course of an injection cycle, or,
(b) at one or more upstream or downstream velocities during the course of an injection cycle, or,
(c) to follow or match a preselected profile of pin positions or pin velocities during the course of an injection cycle, or,
(d) to open or close the gate or to trigger a movement or change in movement at a selected sensed pressure, or,
(e) to trigger an alarm indicative of degree of deviation in pressure of the drive fluid (DF) from one or more preselected desired pressures, or,
(f) upstream beginning from the gate closed position to a selected second intermediate upstream position at a first velocity, upstream from the second intermediate upstream position to a fully gate open position at one or more second velocities that are higher than the first velocity.

In another aspect of the invention there is provided an injection molding system (5) comprising:
an injection molding machine (13, IMM) that delivers an injection fluid to a heated manifold (40) mounted between a top clamp plate (80) and a mold (300) having a cavity (30), the heated manifold adapted to distribute the injection fluid (18) to a flow channel (20f, 22f, 240 that is adapted to pass the injection fluid through a gate (32, 34, 36) to the mold cavity (30);
a first fluid drive cylinder (940c, 941c, 942c) having a first piston (940p, 941p, 942p) disposed within the first fluid drive cylinder (940c, 941c, 942c) adapted to be driven reciprocally upstream and downstream within the first fluid drive cylinder (940c, 941c, 942c);
a second fluid drive cylinder (940ac, 941ac, 942ac) having a second piston (940ap, 941ap, 942ap) disposed within the second fluid drive cylinder (940ac, 941ac, 942ac) and interconnected to a valve pin (1040, 1041, 1042)
wherein the first fluid drive cylinder (940c, 941c, 942c) and the second fluid drive cylinder (940ac, 941ac, 942ac) are interconnected in an arrangement wherein reciprocating movement of the first piston (940p, 941p, 942p) drives concomitant back and forth movement of the second piston (940ap, 941ap, 942ap) and concomitant back and forth movement of the valve pin along a selected path of travel (Y) within the flow channel (20f, 22f, 240 between gate closed and gate open positions;
an electrically powered actuator (940, 941, 942) adapted to drive the first piston (940p, 941p, 942p) reciprocally within the first fluid drive cylinder (940c, 941c, 942c) according to a program that instructs the valve pin (1040, 1041, 1042) to be driven between the gate closed and gate open positions and one or more selected positions therebetween.

In such an apparatus the second actuator (940a, 941a, 942a) is typically mounted to noe or the other or both of the heated manifold (40) and the top clamp plate (80).

In such an apparatus the electrically powered actuator (940, 941, 942) is typically the sole source of drive force on the first piston (940p, 941p, 942p).

In such an apparatus the first fluid drive cylinder (940c, 941c, 942c) and the second fluid drive cylinder (940ac, 941ac, 942ac) are typically drivably interconnected in a closed fluid circuit arrangement.

In such an apparatus the electrically powered actuator (940, 941, 942) is typically mounted in a position remote from the heated manifold (40).

In another aspect of the invention there is provided an injection molding apparatus (5) comprising an injection molding machine (13) that injects a flow of injection fluid (18) to a heated manifold (40) mounted between a top clamp plate (80) and a mold (300) having a mold cavity (30), the manifold distributing the injection fluid (18) to a flow channel (20f, 22f, 240 that delivers the injection fluid to a gate (32, 34, 36) of the mold cavity (30), a valve pin (1040, 1041, 1042) adapted to be controllably driven upstream and downstream within the flow channel (20f, 22f, 240 between gate closed and gate open positions, the injection molding apparatus (5) further comprising:
an electrically powered actuator (940, 941, 942) comprised of an electrically driven device (940r, 941r, 942r) that is interconnected to a drive shaft (940s, 941s, 942s) in an arrangement such that the drive shaft (940s, 941s, 942s) is driven reciprocally back and forth along a selected shaft path (X), the drive shaft (940s, 941s, 942s) being interconnected to a first piston (940p, 941p, 942p) disposed within a first fluid drive cylinder (940c, 941c, 942c), the first piston (940p, 941p, 942p) being adapted to be reciprocally drivable upstream and downstream within the first fluid drive cylinder by driven back and forth movement of the drive shaft (940s, 941s, 942s),
a second actuator (940a, 941a, 942a) comprised of a second piston (940ap, 941ap, 942ap) disposed within a second fluid drive cylinder (940ac, 941ac, 942ac), the second piston (940ap, 941ap, 942ap) being adapted to be reciprocally drivable back and forth along an injection fluid flow control path of travel (Y) within the second fluid drive cylinder (940ac, 941ac, 942ac),
the first fluid drive cylinder (940c, 941c, 942c) and the second fluid drive cylinder (940ac, 941ac, 942ac) being interconnected in an arrangement wherein driven back and forth movement of the first piston (940p, 941p, 942p) drives concomitant back and forth movement of the second piston (940ap, 941ap, 942ap).

The second piston is typically adapted to drive the valve pin (1040, 1041, 1042) upstream and downstream along the injection fluid flow control path of travel (Y) through the flow channel (20f, 22f, 240 between gate closed and one or more gate open positions.

The first piston (940p, 941p, 942p and the first fluid drive cylinder (940c, 941c, 942c) preferably form first upstream and first downstream fluid sealed drive chambers (940uc, 940dc) and wherein the second piston and the second fluid drive chamber form second upstream and second downstream fluid sealed drive chambers (940auc, 940adc), the first upstream and first downstream fluid sealed drive chambers (940uc, 940dc) and the second upstream and second downstream fluid sealed drive chambers (940auc, 940adc) being interconnected in an arrangement such that back and forth movement of the first piston (940p, 941p, 942p) drives concomitant back and forth movement of the second piston (940ap, 941ap, 942ap) along the injection fluid flow control path of travel (Y).

The second piston (940ap, 941ap, 942ap) is typically interconnected to a valve pin (1040, 1041, 1042) adapted to be driven by the second piston (940ap, 941ap, 942ap) along a reciprocal upstream and downstream path of linear travel (Y) between a gate closed and a gate open position.

The second actuator (940a, 941a, 942a) is mounted to one or the other or both of the heated manifold (40) and the top clamp plate (80).

The electrically powered actuator (940, 941, 942) is typically mounted in a position remote from the heated manifold (40).

The electrically powered actuator is preferably mounted such that the electrically powered actuator is isolated from substantial communication of heat with the heated manifold (40).

The electrically powered actuator (940, 941, 942) and the first fluid drive cylinder (940c, 941c, 942c) are typically mounted in a position remote from the heated manifold (40).

The electrically powered actuator (940, 941, 942) and the first fluid drive cylinder (940c, 941c, 942c) are preferably mounted such that the electrically powered actuator (940, 941, 942) and the first fluid drive cylinder (940c, 941c, 942c) are isolated from substantial communication of heat with the heated manifold (40).

The first fluid drive cylinder (940c, 941c, 942c) and the second fluid drive cylinder (940ac, 941ac, 942ac) are typically interconnected via fluid sealed conduit (500, 600) that enables drive fluid to flow between the first fluid drive cylinder (940c, 941c, 942c) and the second fluid drive cylinder (940ac, 941ac, 942ac), the fluid sealed conduit including one or more connectors (700) adapted to enable the conduit interconnection (500, 600) between the first fluid drive cylinder (940c, 941c, 942c) and the second fluid drive cylinder (940ac, 941ac, 942ac) to be readily disconnected and readily connected.

The electrically driven device (940r, 941r, 942r) preferably comprises a rotatably driven rotor (940r) interconnected to the drive shaft (940s, 941s, 942s) by a driver (940ls) in arrangement wherein driven rotation of the driven rotor (940r) drives the driver (940ls) along a selected linear converter path of travel (X, XX).

The driver (940ls) is typically interconnected to or integral with the drive shaft (940s, 941s, 942s) in an arrangement wherein driven travel of the driver (940ls) along the selected linear path of converter travel (X, XX) drives the drive shaft (940s, 941s, 942s) along a selected linear shaft path of travel (X).

The selected linear converter path of travel (X, XX) can be coaxial or non coaxial relative to the selected linear shaft path of travel (X).

The driver (940ls) is typically interconnected to an input end (9401i) of a linear to linear converter (9401) that is interconnected via an output end (940o) to the drive shaft (940s, 941s, 942s), the linear to linear converter (9401) converting driven movement of the driver (940ls) along the selected linear converter path of travel (XX) to driven movement of the drive shaft (940s, 941s, 942s) along a selected linear shaft path of shaft travel (X) that is non coaxial relative to the selected linear converter path of travel (XX).

The first fluid drive cylinder (940c, 941c, 942c) and the second fluid drive cylinder (940ac, 941ac, 942ac) typically contain a selected drive fluid (DF), typically hydraulic (oil) or pneumatic (gas, air) that is adapted to be selectively driven via driven movement of the first piston (940p, 941p, 942p) as a back and forth flow between the first fluid drive cylinder (940c, 941c, 942c) and the second fluid drive cylinder (940ac, 941ac, 942ac) through fluid flow conduits (500, 600), wherein the second piston (940ap, 941ap, 942ap) is controllably driven back and forth along the flow control path of travel (Y) via selective driven flow of the drive fluid (DF) back and forth between the first fluid drive cylinder (940c, 941c, 942c) and the second fluid drive cylinder (940ac, 941ac, 942ac).

The first fluid drive cylinder typically includes first upstream and first downstream fluid sealed drive chambers (940uc, 940dc) and wherein the second fluid drive chamber includes second upstream and second downstream fluid sealed drive chambers (940auc, 940adc), the selected drive fluid (DF) being driven via driven movement of the first piston (940p, 941p, 942p) as a back and forth flow between the first and second upstream drive chambers (940uc, 940auc) and between the first and second downstream drive chambers (940dc, 940adc), or between the first upstream drive chamber (940uc) and the second downstream drive chamber (940adc) and between the first downstream drive chamber (940dc) and the second upstream drive chamber (940auc).

The first fluid drive cylinder (940c, 941c, 942c) and the second fluid drive cylinder (940ac, 941ac, 942ac) preferably contain a selected drive fluid (DF) that is adapted to be selectively driven via driven movement of the first piston (940p, 941p, 942p) as a back and forth flow between the first fluid drive cylinder (940c, 941c, 942c) and the second fluid drive cylinder (940ac, 941ac, 942ac) through fluid flow conduits (500, 600), wherein the valve pin (1040, 1041, 1042) is controllably driven back and forth along the flow control path of travel (Y) via selective driven flow of the drive fluid (DF) back and forth between the first fluid drive cylinder (940c, 941c, 942c) and the second fluid drive cylinder (940ac, 941ac, 942ac).

The first fluid drive cylinder typically includes first upstream and first downstream fluid sealed drive chambers (940uc, 940dc) and wherein the second fluid drive chamber includes second upstream and second downstream fluid sealed drive chambers (940auc, 940adc), the selected drive fluid (DF) being driven via driven movement of the first piston (940p, 941p, 942p) as a back and forth flow between the first and second upstream drive chambers (940uc, 940auc) and between the first and second downstream drive chambers (940dc, 940adc), or between the first upstream drive chamber (940uc) and the second downstream drive chamber (940adc) and between the first downstream drive chamber (940dc) and the second upstream drive chamber (940auc).

Such an apparatus can further comprise a controller (16) wherein the drive shaft (940s, 941s, 942s) and the first piston (940p, 941p, 942p) are controllably drivable by the controller (16) according to an algorithm such that the second piston (940ap, 941ap, 942ap) and the valve pin (1040, 1041, 1042) are controllably driven:
(a) to one or more predetermined axial positions during the course of an injection cycle, or,
(b) at one or more upstream or downstream velocities during the course of an injection cycle, or,
(c) to follow or match a preselected profile of pin positions or pin velocities during the course of an injection cycle.

Such an apparatus can further comprise a controller (16) and a pressure sensor (800) adapted to sense pressure of drive fluid (DF) disposed within a fluid drive cylinder (940c, 941c, 942c, 940ac, 941ac, 942ac) and generate a signal indicative of the pressure of the drive fluid (DF), the controller (16) including an algorithm that utilizes one or more signals generated by the pressure sensor (800) as a variable to controllably drive the second piston (940ap, 941ap, 942ap) and the valve pin (1040, 1041, 1042):
(a) to one or more predetermined axial positions during the course of an injection cycle, or,
(b) at one or more upstream or downstream velocities during the course of an injection cycle, or,
(c) to follow or match a preselected profile of pin positions or pin velocities during the course of an injection cycle, or,
(d) to open or close the gate or to trigger a movement or change in movement at a selected sensed pressure,
(e) to trigger an alarm indicative of degree of deviation in pressure of the drive fluid (DF) from one or more preselected desired pressures.

Such an apparatus can further comprise a controller (16) and a position sensor (900) adapted to sense axial position of the second piston (940ap, 941ap, 942ap) or the valve pin (1040, 1041, 1042) and generate a signal indicative of axial position of the second piston or the valve pin, the controller (16) including an algorithm that utilizes one or more signals generated by the position sensor (900) as a variable to controllably drive the second piston (940ap, 941ap, 942ap) and the valve pin (1040, 1041, 1042):
(a) to one or more predetermined axial positions during the course of an injection cycle, or,
(b) at one or more upstream or downstream velocities during the course of an injection cycle, or,
(c) to follow or match a preselected profile of pin positions or pin velocities during the course of an injection cycle, or,
(d) to open or close the gate or to trigger a movement or change in movement at a selected sensed pressure,
(e) to trigger an alarm indicative of degree of deviation in position or velocity of the second piston or the valve pin from one or more preselected desired positions or velocities.

Such an apparatus can further comprise a controller (16) and a position sensor (950) adapted to sense one or more of axial position of a piston, rotational position and velocity of a rotor (940r) of the electrically powered actuator (940, 941, 942) and generate a signal indicative of one or the other or both of rotational position and velocity of the rotor (940r), the controller (16) including an algorithm that utilizes one or more signals generated by the position sensor (950) as a variable to controllably drive the second piston (940ap, 941ap, 942ap) and the valve pin (1040, 1041, 1042):
(a) to one or more predetermined axial positions during the course of an injection cycle, or,
(b) at one or more upstream or downstream velocities during the course of an injection cycle, or,
(c) to follow or match a preselected profile of pin positions or pin velocities during the course of an injection cycle, or,
(d) to open or close the gate or to trigger a movement or change in movement at a selected sensed pressure,
(e) to trigger an alarm indicative of degree of deviation in position or velocity of the second piston or the valve pin from one or more preselected desired positions or velocities.

Such an apparatus can further comprise a controller (16) and a sensor (950) adapted to sense one or the other or both torque exerted by or current used by the electrically powered actuator (940, 941, 942) and generate a signal indicative of one or the other or both of torque and current, the controller (16) including an algorithm that utilizes one or more signals generated by the sensor (950) as a variable to controllably drive the second piston (940ap, 941ap, 942ap) and the valve pin (1040, 1041, 1042):
(a) to one or more predetermined axial positions during the course of an injection cycle, or,
(b) at one or more upstream or downstream velocities during the course of an injection cycle, or,
(c) to follow or match a preselected profile of pin positions or pin velocities during the course of an injection cycle, or,
(d) to open or close the gate or to trigger a movement or change in movement at a selected sensed pressure,
(e) to trigger an alarm indicative of degree of deviation in position or velocity of the second piston or the valve pin from one or more preselected desired positions or velocities.

The valve pin (1040, 1041, 1042) can include a flow control surface (102mds) disposed axially upstream of a distal tip end (1041de) of the valve pin and the flow channel (20f, 22f, 240 includes a complementary flow control surface (103s, 103ts) disposed upstream and away from the gate (32), the flow control surfaces (102mds, 103s, 103ts) being adapted to interface with each other to vary rate or velocity of flow of the injection material to and through the gate (32, 34, 36) via controlled axial positioning of the valve pin, wherein apparatus includes:
a sensor (PS0) that senses pressure of the injection material within the flow channel (20f, 22f, 240 upstream and away from the gate (32, 34, 36),
a controller (16) that includes a program that receives signals from the sensor (PS0) indicative of the sensed pressure, the program generating instructions based on the received signals that are sent to the electrically powered actuator (940, 941, 942)), the instructions controlling interfacing of the flow control surfaces (102mds, 103s, 103ts) to control the rate or velocity of flow of the injection material during the course of an injection cycle.

The controller (16) can include a profile of preselected pressures extending over the course of an injection cycle, the program generating instructions based on the received signals that control interfacing of the flow control surfaces (102mds, 103s, 103ts) to adjust pressure of the injection fluid (18) sensed by the pressure sensor (PS0) to be adjusted to match the profile of preselected pressures extending over the course of the injection cycle.

The electrically powered actuator can includes an electrical drive device (940d, 941d, 942d) comprised of an interface that receives drive signals (DC) from a controller (16) and controllably distributes electrical energy or power in controllably varied amounts according to the drive signals (DC) to a driver (940dr, 941dr, 942dr) that drives the rotor (940r, 941r, 942r),

The electrical drive device (940d, 941d, 942d) typically receives electrical energy or power from a power source (PS) and controllably distributes the received electrical energy or power in controllably varied amounts during the course of an injection cycle to a driver (940dr, 941dr, 942dr) of the electrically powered actuator (940).

The electrical drive device (940d, 941d, 942d) typically includes a pulse-width modulator (PWM) that converts received electrical energy or power into sinusoidal voltage waveforms, each sinusoidal voltage waveform being adapted to drive a corresponding phase-coil of the actuator driver (940dr, 941dr, 942dr).

The pulse-width modulator (PWM) can comprise an inverter or a comparator.

The pulse width modulator (PWM) can comprise a three-phase inverter that converts electrical energy or power received from the interface into three sinusoidal voltage waveforms, each one of the three sinusoidal voltage waveforms being adapted to drive a corresponding one of three phase-coils of the actuator driver.

The electrical energy or power received at or by the pulse width modulator (PWM) can comprise a DC bus voltage.

The interface of the electrical drive (940d, 941d, 942d) is preferably adapted to receive one or more control signals from a controller (16) of the injection molding apparatus (10) and to convert electrical energy or power received from the power source (PS) into sinusoidal waveforms based on the one or more control signals.

The interface is typically comprised of the pulse width modulator (PWM) which converts electrical energy or power received from the power source into sinusoidal waveforms based on the one or more control signals.

The one or more control signals received by the interface can contain control information causing the pulse width modulator (PWM) to convert the received electrical energy or power into sinusoidal waveforms adapted to drive the corresponding phase-coils of the actuator driver to adjust one or more of a position, a velocity or torque of the actuator rotor (940r, 941r, 942r).

The one or more control signals typically comprise analog electrical signals received at the electrical drive from the controller (16).

The electrical drive (940d, 941d, 942d) can comprises one or the other or both of a digital signal receiving (16r) and transmitting (16s) device, wherein: the digital signal receiving and transmitting device is adapted to receive (16r) and transmit (16s) digital signals between the electrical drive (940d, 941d, 942d) and the controller (16) of the injection molding apparatus (10); and wherein, the digital signals include the one or more control signals, where the one or more control signals are digital control signals received from the controller.

The digital control signals can include one or more of differential position commands, differential current commands, and differential velocity commands.

The digital signal receiving and transmitting device (16r, 16s) can be adapted to receive digital signals from the actuator, wherein: the digital signals received from the actuator include one or more feedback signals corresponding to operation of one or more of the actuator and the actuator rotor.

The pulse width modulator (PWM) preferably converts the electrical energy or power received from the interface into sinusoidal waveforms adapted to drive the corresponding phase-coils of the actuator driver based at least in part on the one or more feedback signals.

The one or more feedback signals received from the actuator typically includes one or more of an incremental feedback signal and an absolute feedback signal.

The electrically powered actuator (940, 941, 942) typically comprises a driver (940dr, 941dr, 942dr) comprised of one or more of a stator and armature that are interconnected to a rotatably mounted rotor or shaft (940r, 941r, 942r) such that when the drivers (940dr, 941dr, 942dr) rotate on application and receipt of electrical energy or power, the shafts (940r, 941r, 942r) are rotated.

The rotor (940r, 941r, 942r) typically has a drive axis (Y), the driver (940dr, 941dr, 942dr) being interconnected to the rotor (940r, 941r, 942r) and adapted to controllably drive the rotor (940r, 941r, 942r) rotatably around the drive axis Y.

The driver (940dr, 941dr, 942dr) typically receives electrical energy or power from the electrical drive (940d, 941d, 942d).

The electrical drive (940d, 941d, 942d) can be housed within or by the housing (940h, 941h, 942h) or is physically mounted on or to the housing (940h, 941h, 942h) in thermally conductive communication or contact therewith.

The apparatus described above can further comprise a signal converter (1500) for converting signals generated by an injection molding apparatus (10) that is comprised of an injection molding machine (IMM) having a drivably rotatable barrel screw (BS) that generates an injection fluid (18), a heated manifold (40) that receives an injection fluid (18) from the injection molding machine (IMM) and distributes the injection fluid (18) to one or more gates (32, 34, 36), a mold (42) having a cavity (30) communicating with the gates to receive the injection fluid (18), wherein the injection molding machine (IMM) includes a machine controller (MC) or a control unit (HPU) that generates one or more directional control valve compatible signals (VPS), wherein the direction control valve compatible signals (VPS) are compatible for use by a signal receptor, interface or driver of a standard fluid directional control valve (12) to instruct the fluid directional control valve (12) to move to a position that routes a source of drive fluid to flow in a direction that drives an interconnected fluid drivable actuator (940f, 941f, 9420 to move in a direction that operates to begin an injection cycle and to move in a direction that operates to end an injection cycle,
wherein the signal converter (1500) is interconnected to the machine controller (MC) or control unit (HPU), the signal converter (1500) receiving and converting the directional control valve compatible signals (VPS) to a command signal (MOPCS, PDCVS) that is compatible with a signal receptor or interface of an electrically powered actuator (940e, 941e, 942e) or a signal receptor or interface of a proportional directional control valve (V, V1, V2) that drives a fluid driven actuator (940p, 941p, 942p),
wherein the signal converter (1500) includes a processor that converts the command signals (MOPCS, PDCVS) into a form, frequency, power or format that is usable by the signal receptor or interface of the electrically powered actuator (940e, 941e, 942e) or by the signal receptor or interface of the proportional directional control valve (V, V1, V2) to respectively cause the electrically powered actuator (940e, 941e, 942e) or the proportional directional control valve (V, V1, V2) to be driven in a direction that operates to either begin an injection cycle or to end an injection cycle.

The directional control valve compatible signals (VPS) comprise a voltage signal of predetermined voltage or magnitude indicative of a predetermined rotational position of the barrel screw (BS) of the injection molding machine (IMM) that generates pressurized injection fluid (18) within the apparatus.

The apparatus (10) can further comprise one or more sensors (950, 951, 952, SN, SC, SPSR, BPSR) that detect and generate one or more sensor signals indicative of one or more of rotational or linear position of an actuator (940e, 941e, 942e, 940p, 941p, 942p) or its associated valve pin (1040, 1041, 1042), pressure or temperature of the injection fluid (18) within a fluid channel (19) of the manifold (40) or within a nozzle channel (42, 44, 46) or within the cavity (30) of the mold (33) or within a barrel of the injection molding machine (IMM), the apparatus (10) including an actuator controller (16) that receives and uses the one or more sensor signals in a program that:
instructs the actuator (940e, 941e, 942e, 940p, 941p, 942p) or its associated valve pin (1040, 1041, 1042) to travel during the course of the injection cycle to positions that correspond to a predetermined profile of injection fluid pressures, linear or rotational pin positions, linear actuator or valve pin positions, barrel screw positions, barrel pressures or actuator drive fluid pressures or that,
instructs the actuator (940e, 941e, 942e, 940p, 941p, 942p) or its associated valve pin (1040, 1041, 1042) such that the valve pin is withdrawn from a closed gate position upstream at a reduced velocity over a selected path of upstream travel, or that,
instructs the actuator (940e, 941e, 942e, 940p, 941p, 942p) or its associated valve pin (1040, 1041, 1042) to travel such that the valve pin is driven downstream at a reduced velocity over a selected path of travel where a distal tip end of the pin travel from upstream of the gate to a gate closed position, or that,
instructs the actuator (940e, 941e, 942e, 940p, 941p, 942p) or its associated valve pin (1040, 1041, 1042) to travel such that the valve pin is driven upstream or downstream to an intermediate position between a gate closed position and a fully upstream position where the valve pin is maintained in the intermediate position for a selected period of time during the course of the injection cycle wherein, in the intermediate position, the distal tip end of the valve pin restricts flow of injection of the injection to less than a maximum flow.

In another aspect of the invention there is provided, an injection molding apparatus (5) comprising an injection molding machine (13) that injects a flow of injection fluid (18) to a heated manifold (40) mounted between a top clamp plate (80) and a mold (300) having a mold cavity (30), the manifold distributing the injection fluid (18) to a flow channel (20f, 22f, 240 that delivers the injection fluid to a gate (32, 34, 36) of the mold cavity (30), a valve pin (1040, 1041, 1042) adapted to be controllably driven upstream and downstream within the flow channel (20f, 22f, 240 between gate closed and gate open positions, the injection molding apparatus (5) further comprising:
an electrically powered motor (940, 941, 942) having a linearly driven shaft (940ls) interconnected to a rod (940s, 941s, 942s) of first piston (940p, 941p, 942p) disposed within a first fluid drive cylinder (940c, 941c, 942c), the first piston (940p, 941p, 942p) being reciprocally drivable upstream and downstream within the first fluid drive cylinder by driven back and forth movement of the linearly driven shaft (940ls),
a second actuator (940a, 941a, 942a) comprised of a second piston (940ap, 941ap, 942ap) disposed within a second fluid drive cylinder (940ac, 941ac, 942ac), the second piston (940ap, 941ap, 942ap) being adapted to be reciprocally drivable back and forth along an injection fluid flow control path of travel (Y) within the second fluid drive cylinder (940ac, 941ac, 942ac),
the first fluid drive cylinder (940c, 941c, 942c) and the second fluid drive cylinder (940ac, 941ac, 942ac) being interconnected in an arrangement wherein driven back and forth movement of the first piston (940p, 941p, 942p) drives concomitant back and forth movement of the second piston (940ap, 941ap, 942ap),
the second piston being adapted to drive the valve pin (1040, 1041, 1042) upstream and downstream along the injection fluid flow control path of travel (Y) through the flow channel (20f, 22f, 240 between gate closed and one or more gate open positions.

In such an apparatus as described above the electrically powered actuator (940, 941) can drive the valve pin (1040, 1041, 1042) upstream along a path of travel between a downstream gate closed position and one or more intermediate upstream gate open positions, the downstream gate closed position being a position wherein the tip end (1142, 1155) of the valve pin obstructs the gate (32, 34, 36) to prevent fluid material (18, 1153) from flowing into the mold cavity (30), the one or more intermediate upstream gate open positions (COP, COP2) being predetermined positions between the downstream gate closed position and a fully open, end of stroke position (EOS) upstream of the intermediate upstream gate open position at which the fluid mold material flows at a maximum rate through the gate, wherein the gate is partially open when the valve pin is in the one or more intermediate upstream gate open positions; the apparatus further including
a position sensor (900, 950) that senses position of the valve pin (1040) or the piston or the electrically powered actuator (940, 941, 942),
a controller (16) interconnected to the electrically powered actuator (940) and to the position sensor (900, 950) that controls movement of the electrically powered actuator at least in part according to instructions that instruct the electrically powered actuator to drive the valve pin (1040, 1041) upstream at one or more selected intermediate velocities over the course of travel of the valve pin through the one or more intermediate upstream gate open positions (COP, COP2) in response to receipt by the controller of a signal from the position sensor (900, 950) that the valve pin is disposed in the one or more intermediate upstream gate open positions,
the valve pin being drivable at a maximum upstream velocity, the one or more selected intermediate velocities being less than the maximum velocity.

In such an apparatus the tip end (1142, 1153) of the valve pin and a surface (1254) the gate (32, 34) are typically adapted to cooperate with each other to restrict and continuously increase rate of flow of the fluid material through the gate over the course of at least a portion of the upstream travel of the valve pin from the downstream gate closed position to the intermediate upstream gate open position.

In such an apparatus the instructions can instruct velocity of the valve pin to be adjusted to a selected higher velocity in response to a signal generated by the sensor (900, 950) having detected and indicating the valve pin has reached the intermediate upstream gate open position.

The selected higher velocity is typically a maximum velocity at which the actuator is capable of driving the valve pin.

In such an apparatus the tip end of the valve pin and the gate can be adapted to cooperate with each other to restrict to less than the maximum flow rate and continuously increase rate of flow of the fluid material through the gate over the course of at least a portion of the continuous upstream travel of the valve pin from the downstream gate closed position to the intermediate upstream gate open position.

The one or more selected intermediate velocities are typically less than about 75% of the higher velocities.

The one or more selected intermediate velocities are typically a single selected velocity.

The instructions of the controller can utilize the signals received from the sensor to calculate real time velocity of the valve pin and compare the calculated real time velocity to one or more predetermined velocities for the pin during the course of travel of the tip end of the pin from at least the downstream gate closed position to the intermediate upstream gate open position.

The controller (16) can include instructions that compares the calculated real time velocity to the predetermined velocities and instruct the sending of a signal instructing the actuator to match the velocity of the pin to the predetermined velocities based on the comparison at any given position of the valve pin.

The controller can include instructions that calculate real time velocity based on a value corresponding to the position of the pin signal received in real time from the sensor.

The controller (16), in response to the one or more signals received from the sensors (900, 950), can instruct the electrically powered actuator to move the valve pin upstream of the one or more intermediate upstream gate open positions to a fully open, end of stroke position at one or more velocities that are higher than the one or more velocities of the valve pin during travel from the downstream gate closed position to the intermediate upstream gate open position.

In another aspect of the invention there is provided a method of performing an injection molding cycle comprising operating any apparatus or device as described herein to perform an injection cycle.

In such an apparatus the electrically powered actuator can be adapted to drive the tip end of the valve pin upstream and downstream between a first closed position where the tip end (1142, 155) of the valve pin obstructs the gate (1254) to prevent the injection fluid from flowing into the cavity, a full open position (FOP) where the injection fluid material flows freely without restriction from the tip end of the pin through the gate, and one or more intermediate positions between the first position and the full open position wherein the tip end of the valve pin restricts flow of the injection fluid along at least a portion of the length of the drive path extending between the first closed position and the intermediate position,
the apparatus including a controller (16) that contains instructions that instruct the actuator to controllably drive the valve pin to be disposed or held in a selected intermediate position for a selected period of time during the course of an injection cycle where the tip end of the valve pin restricts flow of injection fluid through the gate to the mold cavity.

The controller can include instructions that instruct the actuator to drive the valve pin downstream beginning from the full open (FOP) or end of stroke (EOS) position to the selected intermediate position, to hold the valve pin in the selected intermediate position for the selected period of time, and to subsequently drive the valve pin downstream from the selected intermediate position to the first closed position.

The controller can include instructions that instruct the actuator to drive the valve pin downstream beginning from the full open or end of stroke position at a high rate of downstream travel, to subsequently drive the valve pin downstream at one or more of the intermediate rates of downstream travel the selected intermediate position, to subsequently hold the valve pin in the selected intermediate position for the selected period of time and to subsequently drive the valve pin downstream from the selected intermediate position to the first closed position.

The controller can includes instructions that instruct the actuator to controllably drive the valve pin upstream beginning from the first closed position to the selected intermediate position, to hold the valve pin in the selected intermediate position for the selected period of time, and to subsequently drive the valve pin upstream from the intermediate position to the full open or end of stroke position.

The controller can include instructions that instruct the actuator to drive the valve pin upstream beginning from the first closed position at a reduced rate of upstream travel, to subsequently hold the valve pin in the selected intermediate position for the selected period of time and to subsequently drive the valve pin upstream from the intermediate position to the full open or end of stroke position at a high rate of upstream travel greater than the reduced rate of upstream travel.

In another aspect of the invention there is provided a method of performing an injection molding cycle in an injection molding apparatus as described above comprising:
driving the electrically powered actuator such that the tip end of the valve pin obstructs the gate to prevent the injection fluid from flowing into the cavity, and such that the valve pin is driven to a full open or end of stroke position where the injection fluid material flows freely without restriction from the tip end of the pin through the gate, and one or more intermediate positions between the first position and the full open position wherein the tip end of the valve pin restricts flow of the injection fluid along at least a portion of the length of the drive path extending between the first closed position and the intermediate position, and,
controllably operating the electrically powered actuator to drive the valve pin upstream beginning from the first position at a reduced rate of upstream travel relative to a selected high rate of upstream travel and subsequently holding the valve pin in the selected intermediate position for a selected period of time.

Such a method can further comprise subsequently driving the valve pin upstream from the selected intermediate position to the full open or end of stroke position at the selected high rate of upstream travel.

Such a method can further comprise controllably operating the actuator to drive the valve pin downstream beginning from the full open position at a selected high rate of downstream travel, subsequently driving the valve pin downstream at one or more intermediate rates of downstream travel that are less than the selected high rate of downstream travel.

In such a method the high rate of upstream travel can be a maximum rate of upstream travel.

In such a method the selected intermediate position in which the valve pin is disposed or held can be a position at which pressure of the injection fluid is a pack pressure.

In another aspect of the invention the electrically powered actuator can be adapted to drive the valve pin upstream and downstream along the axis (Y) and to drive the tip end (1142, 1155) of the valve pin upstream and downstream between a first closed position where the tip end of the valve pin obstructs the gate to prevent the injection fluid from flowing into the cavity, a full open or end of stroke position where the injection fluid material flows freely without restriction from the tip end of the pin through the gate, and one or more intermediate positions between the first position and the full open position wherein the tip end of the valve pin restricts flow of the injection fluid along at least a portion of the length of the drive path extending between the first closed position and the one or more intermediate positions, the apparatus including a controller (16) that contains instructions that instruct the actuator to controllably drive the valve pin upstream beginning from the first closed position at a reduced rate of upstream travel relative to a high rate of upstream travel to a selected intermediate position and to hold the valve pin in the selected intermediate position for a selected period of time.

In another aspect of the invention there is provided a method of performing an injection molding cycle in an injection molding apparatus as described above comprising:
driving the electrically powered actuator such that the valve pin is controllably driven upstream and downstream along the axis (Y) and the tip end of the valve pin is driven upstream and downstream between a first closed position where the tip end (1142, 1155) of the valve pin obstructs the gate to prevent the injection fluid from flowing into the cavity, a full open position where the injection fluid material flows freely without restriction from the tip end of the pin through the gate at a maximum pressure, and an intermediate position between the first position and the full open position wherein the tip end of the valve pin restricts flow of the injection fluid along at least a portion of the length of the drive path extending between the first closed position and the intermediate position and where the injection fluid flows through the gate at a reduced pressure relative to the maximum pressure, and,
controllably operating the electrically powered actuator to drive the valve pin to be disposed or held in a selected intermediate position for a selected period of time during the course of an injection cycle such that the pressure of the injection fluid is held at a selected reduced pressure relative to the maximum pressure for the selected period of time.

In another aspect of the invention there is provided a method of performing an injection molding cycle in an injection molding apparatus as described above comprising:
drivably interconnecting the valve pin to the electrically powered actuator in an arrangement wherein the electrically powered actuator drives the valve pin upstream and downstream along the axis (Y) and drives the tip end (1142, 1155) of the valve pin upstream and downstream between a first closed position where the tip end of the valve pin obstructs the gate to prevent the injection fluid from flowing into the cavity and a full open position where the injection fluid material flows freely without restriction from the tip end of the pin through the gate at a maximum pressure,
wherein pressure of the injection fluid associated with the nozzle varies between zero at the beginning of the injection cycle when the valve pin is in the first closed position and the maximum pressure, the position of the valve pin between the first closed position and the full open position being controllably variable to vary the pressure of the injection fluid,
the method further comprising controllably operating the electrically powered actuator to drive the valve pin to be disposed or held in a position intermediate the closed position and the full open or end of stroke position for a selected period of time during the course of an injection cycle where the pressure of the injection fluid is held at a selected reduced pressure relative to the maximum pressure. The selected intermediate position in which the valve pin is disposed or held can be a position at which pressure of the injection fluid is a pack pressure.

In another aspect of the invention in an apparatus as described above the electrically powered actuator (940, 941, 942) drives the valve pin upstream and downstream along the axis and drives the tip end of the valve pin upstream and downstream between a first closed position where the tip end of the valve pin obstructs the gate to prevent the injection fluid from flowing into the cavity and a full open position where the injection fluid material flows freely without restriction from the tip end of the pin through the gate at a maximum pressure,
wherein pressure of the injection fluid associated with the nozzle varies between zero at the beginning of the injection cycle when the valve pin is in the first closed position and the maximum pressure, the position of the valve pin between the first closed position and the full open position being controllably variable to vary the pressure of the injection fluid,
the apparatus including a controller (16) that includes a set of instructions that instruct the actuator to controllably drive the valve pin to be disposed or held in a position intermediate the closed position and the full open position for a selected period of time during the course of an injection cycle such that the pressure of the injection fluid is held at a selected reduced pressure relative to the maximum pressure for the selected period of time.

### BRIEF DESCRIPTION OF THE DRAWINGS

The accompanying drawings contain numbering of components and devices that correspond to the numbering appearing in the following Summary.

FIG. 1 is a side sectional view of a prior art injection molding apparatus employing a single fluid driven actuator to drive a valve pin at a gate.

FIG. 2 is a side sectional view of an apparatus according to the invention showing three valves where each valve comprises a rotary driven electric motor or electrically powered rotary actuator that drives a first fluid driven actuator cylinder which is interconnected to and drives a second fluid driven actuator cylinder that is mounted on, to or in close proximity to a heated manifold or a top clamp plate and is drivably interconnected to a valve pin that is arranged to close and open a gate to a mold cavity. The drive fluid circuit of the FIG. 2 apparatus is such that drive fluid is contained within and driven between the upstream and downstream chambers of one of the fluid driven actuator cylinders to the upstream and downstream chambers of the other of the two fluid driven actuator cylinders.

FIG. 3A is a side schematic sectional view of a system similar to FIG. 2 where the electric actuator is a linear actuator and the first fluid driven actuator is provided with a pressure sensor that sends a real time signal indicative of fluid pressure within the drive chamber of the first fluid driven actuator to a controller and where the second fluid driven actuator is provided with a position sensor that senses position of the valve pin or drive piston and sends a signal indicative of position to the controller that controls drive of the electric actuator.

FIG. 3B is a schematic side sectional view of the armature and drive rod components of a linear drive proportional solenoid that can be substituted for the assembly of rotary motion enabling components of the rotary electric actuators described herein to enable direct linear actuation movement of the drive rod by the armature when energized with electricity.

FIG. 3C is a schematic side sectional view of the armature and drive rod components of a linear motor that can be substituted for the assembly of rotary motion enabling components of the rotary electric actuators described herein to enable direct linear actuation movement of the drive rod by the armature when energized with electricity.

FIG. 3D is a series of plots of valve pin position versus time according to a series of different predetermined electric actuator drive protocols or programs that effect the different series of valve pin positions versus time.

FIG. 4A is a side sectional view of an apparatus similar to the FIG. 2 apparatus where the hydraulic fluid circuit is interconnected to a fluid source and where the first hydraulic actuator is mounted in a position remote from the subassembly of the top clamp plate, mold and heated manifold of the apparatus.

FIG. 4B is a view similar to the FIG. 4 apparatus where the first hydraulic actuator is mounted to the top clamp plate via standoffs which are typically comprised of a heat insulative material such as titanium.

FIG. 4C is a view similar to the FIG. 5 apparatus where the housing of the first hydraulic actuator is mounted to the top clamp plate of the apparatus.

FIG. 4D is a side sectional view of an apparatus similar to the FIG. 2 apparatus where a single first hydraulic actuator drives both of a pair of second downstream hydraulic actuators.

FIG. 4E is a side sectional view of an apparatus similar to the FIG. 2 apparatus where the fluid driven actuator cylinders are pneumatic (gas or air) driven and the fluid circuit allows for venting of the gas or air.

FIG. 5 is a side sectional schematic view of an electric actuator having a drive shaft that drives a piston in a first fluid drive cylinder that is interconnected to and drives a downstream fluid drive cylinder that is interconnected to and drives a valve pin, where the rotor of the electric actuator is coaxially aligned with the linearly driven shaft of the motor and the drive rod of the piston of the first fluid driven actuator and where the downstream second fluid driven cylinder is mounted to the heated manifold.

FIG. 6 is a side sectional schematic view of an electric actuator having a drive shaft that drives a piston in a first fluid drive cylinder that is interconnected to and drives a downstream fluid drive cylinder that is interconnected to and drives a valve pin, where the rotor of the electric actuator is non coaxially arranged relative to the drive the rod of the piston of the first hydraulic actuator and where the downstream second fluid drive cylinder is mounted to the heated manifold.

FIGS. 7A-7E are schematic cross-sectional close-up views of the center and one of the lateral gates 34 of the FIG. 1 apparatus showing various stages of the progress of sequential injection.

FIGS. 8A-8B show tapered end valve pin positions at various times and positions between a starting closed position and various upstream opened positions, RP representing a selectable path length over which the velocity of withdrawal of the pin upstream from the gate closed position to an open position is reduced relative to the velocity of upstream movement that the valve pin would normally have over the uncontrolled velocity path FOV when pin velocity is at its maximum.

FIGS. 9A-9B show a valve pin that has a cylindrically configured tip end, the tips ends of the pins being positioned at various times and positions between a starting closed position and various upstream opened positions, RP wherein RP represents a path of selectable length over which the velocity of withdrawal of the pin upstream from the gate closed position to an open position is reduced relative to the velocity of upstream movement that the valve pin would normally have over the uncontrolled velocity path FOV when the pin velocity is at its maximum.

FIG. 10 is a side sectional view of valve pin having a portion disposed upstream and away from the distal tip end of the pin that is configured to interengage with a complementary inner surface of the downstream nozzle fluid flow channel that is disposed upstream and away from the distal gate or tip end of the nozzle channel, where the axial position of the upstream valve pin portion relative to the complementary inner nozzle channel surface acts to restrict injection fluid flow to varying degrees between full flow and closed or zero flow depending on the axial positioning of the valve pin.

FIG. 11 is a side schematic view of one embodiment of an injection molding system according to the invention where the valve gates include an electrically powered or electric motor containing actuator, the system including a machine signal converter that receives a standard signal generated by an injection machine controller converts the signal to a control signal compatible with the signal receptor of the electrically powered actuators used in the system, the converter routing the converted signal to the actuator processor.

FIG. 11A is a generic schematic diagram of an arrangement of signal communications between an injection molding machine controller, sensors, a signal converter and electric actuators or the interface of a proportional directional control valve.

FIG. 11B is a schematic diagram of an arrangement of signal communications between an injection molding machine controller, position sensors, a signal converter and electric actuators.

FIG. 11C is a schematic diagram of an arrangement of signal communications between an injection molding machine controller, position sensors, a signal converter and the interfaces of proportional directional hydraulic control valves.

FIG. 11D is a schematic diagram of an arrangement of signal communications between an injection molding machine controller, position sensors, a signal converter and the interfaces of proportional directional pneumatic control valves.

FIG. 12 is a side schematic view of another embodiment of an injection molding system according to the invention where the valve gates include a proportional directional control valve, the system including a machine signal converter that receives a standard signal generated by an injection machine controller, converts the signal to a control signal compatible with the signal receptor of the proportional directional control valves used in the system, the converter sending the converted signal to the proportional directional control valves.

FIGS. 13A-13D, 14 are examples of time versus pressure graphs (1235, 1237, 1239, 1241, 1310) generated during a specimen injection cycle by the pressure of injection fluid detected by four pressure transducers associated with and measuring the injection fluid pressure flowing through four nozzles mounted in a manifold block.

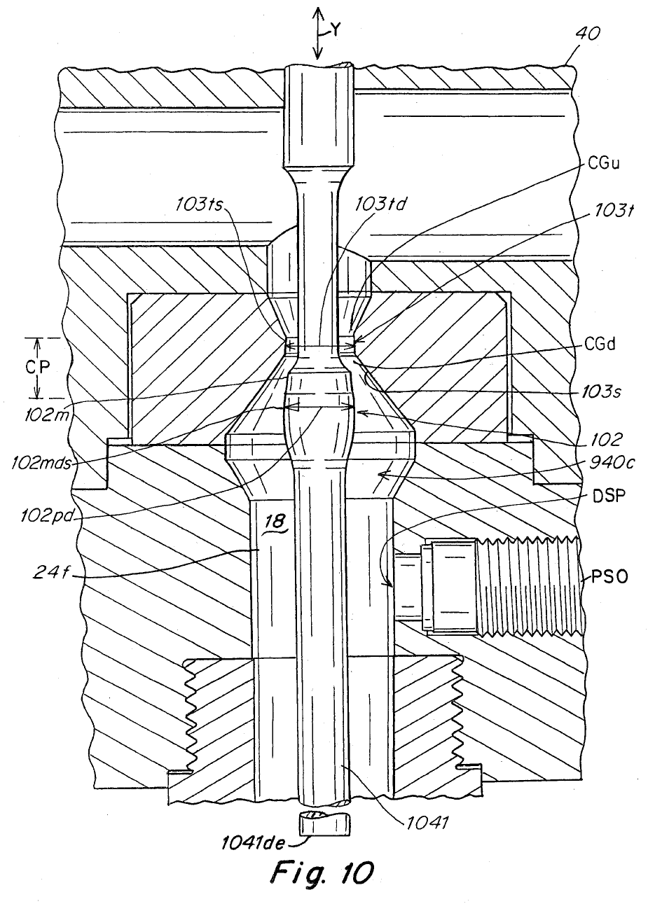

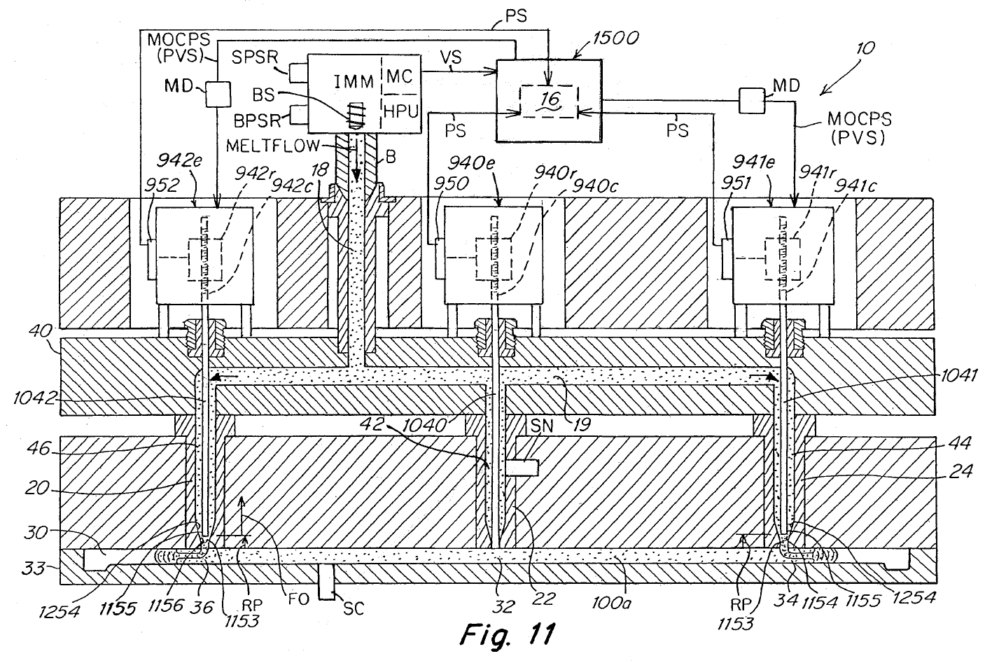

The nozzles can be configured as shown in FIG. 10 where a signal indicative of pressure sensed by the pressure transducers is sent to the controller 16 that uses a sensed pressure value to control movement of the electric actuators that drive the first upstream fluid driven actuator 940c, 941c, 942c which in turn drive the downstream second fluid driven actuators that are interconnected to the valve pins that are driven reciprocally upstream and downstream through the flow channel of the nozzles. FIG. 10 shows a nozzle and associated valve pin having a portion disposed upstream and away from the distal tip end of the pin that is configured to interengage with a complementary inner surface of the downstream nozzle fluid flow channel that is disposed upstream and away from the distal gate or tip end of the nozzle channel, where the axial position of the upstream valve pin portion relative to the complementary inner nozzle channel surface acts to restrict injection fluid flow to varying degrees between full flow and closed or zero flow depending on the axial positioning of the valve pin.

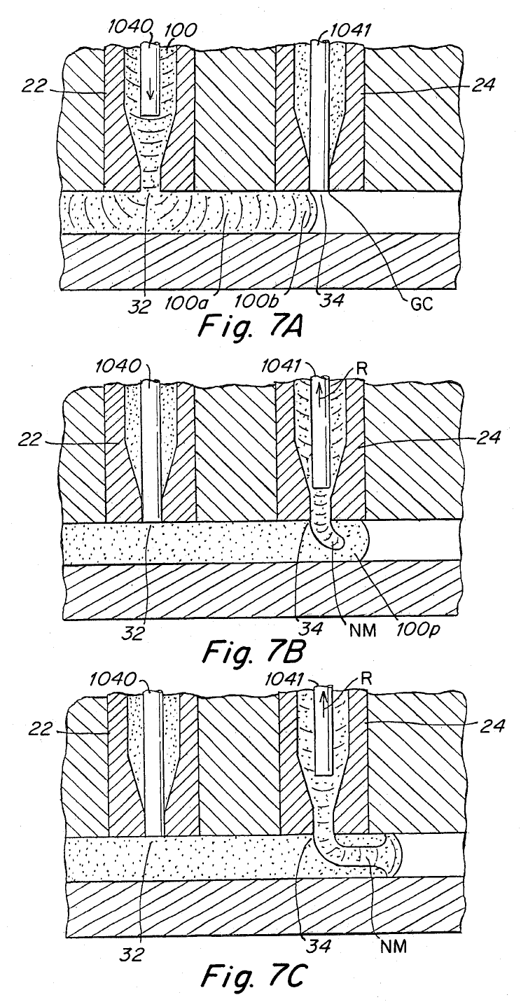

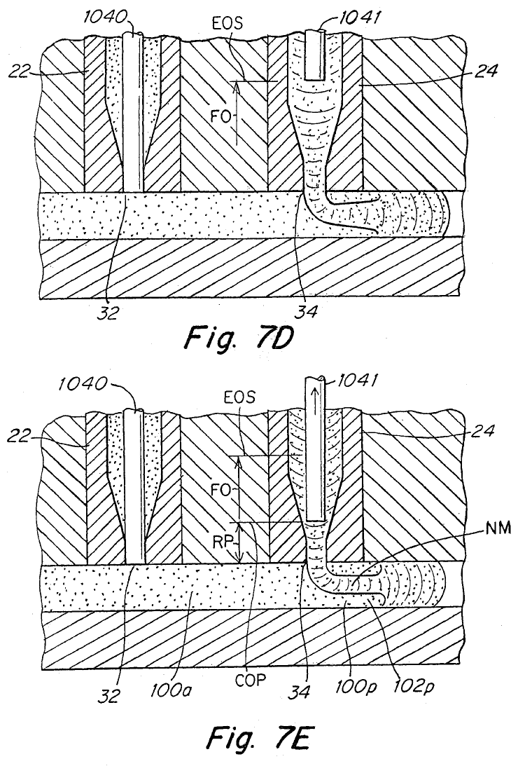

Such a valve pin and nozzle configuration as shown in FIG. 10, can be used to effect an injection fluid flow that is slower beginning from a gate closed or flow stopped position of the valve pin and higher as the valve pin is controllably moved toward a predetermined axial position in the same manner as described herein with respect to the FIGS. 7A-7E, 8A, 8B, 9A, 9B configurations. The gate closed or injection fluid flow stopped position of the FIG. 10 configuration occurs when the pin surface 102mds is engaged with the throat surface 103ts. Starting from such a gate closed position, the valve pin 1041 of FIG. 10 can be controllably moved upstream or downstream to an axial position at one or more an initially slow velocities to effect a slow injection fluid flow through the gate into the cavity 30 in the same manner as described with respect to the FIGS. 7A-9B pin configuration to effect an initial slow injection fluid at the beginning of an injection. And subsequent to the initially slow velocity movement of the FIG. 10 valve pin configuration, the axial position of the valve pin 1041 can be sensed and detected and the pin subsequently moved at a higher upstream or downstream velocity when the pin is sensed and determined to have reached a predetermined upstream or downstream axial position in the same manner as described with respect to the FIGS. 7A-9B embodiments. When the FIG. 10 valve pin has reached the predetermined upstream or downstream axial position, the valve pin can be further moved at a higher velocity than the initial slow velocity to move the pin to a position where injection fluid flow through the gate into the cavity 30 is at a predetermined high velocity typically at maximum velocity in the same manner as described with reference to the FIGS. 7A-9B embodiments.

### DETAILED DESCRIPTION OF THE INVENTION

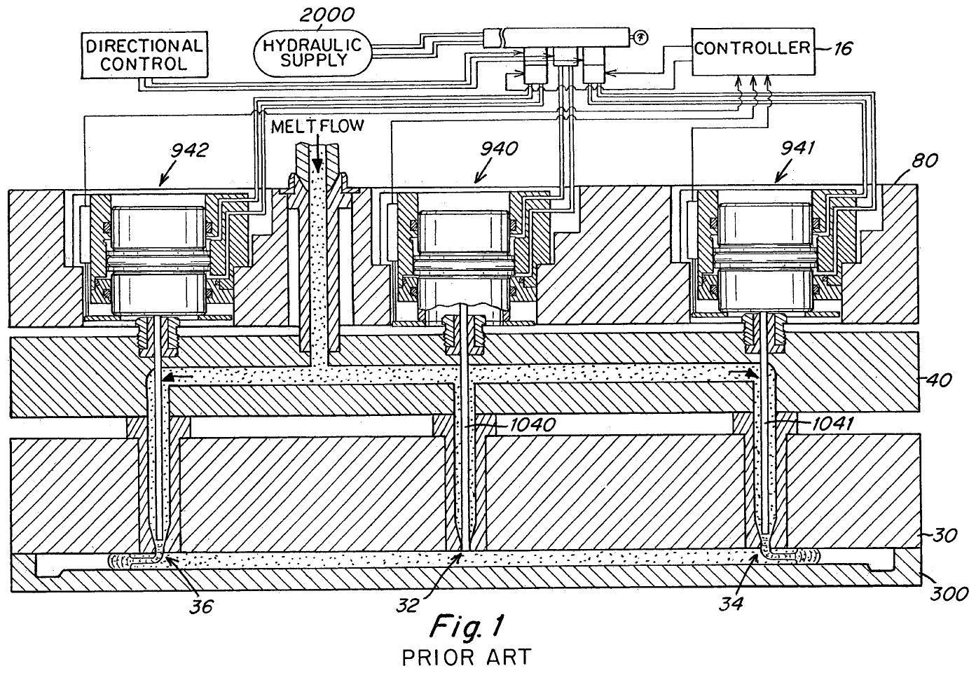

FIG. 1 shows a prior art injection molding apparatus employing a single fluid driven actuator to drive a valve pin to open and close a gate.

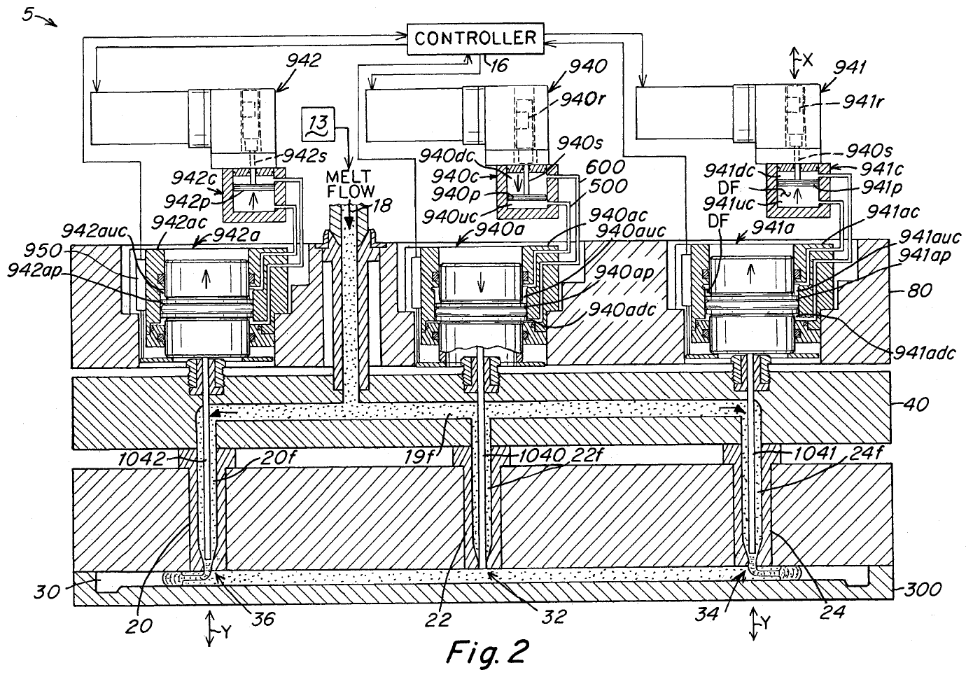

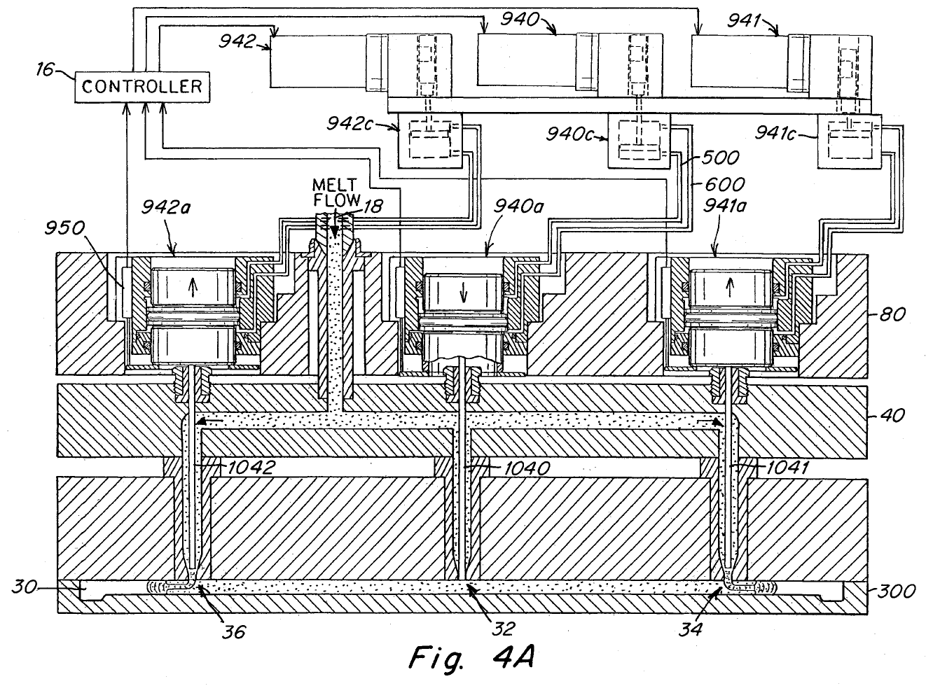

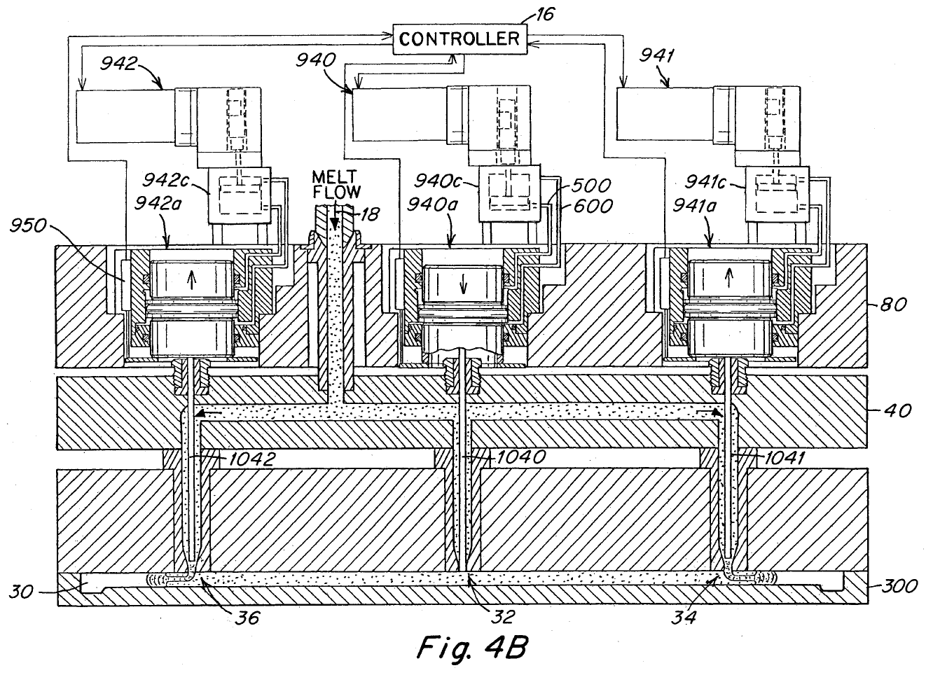

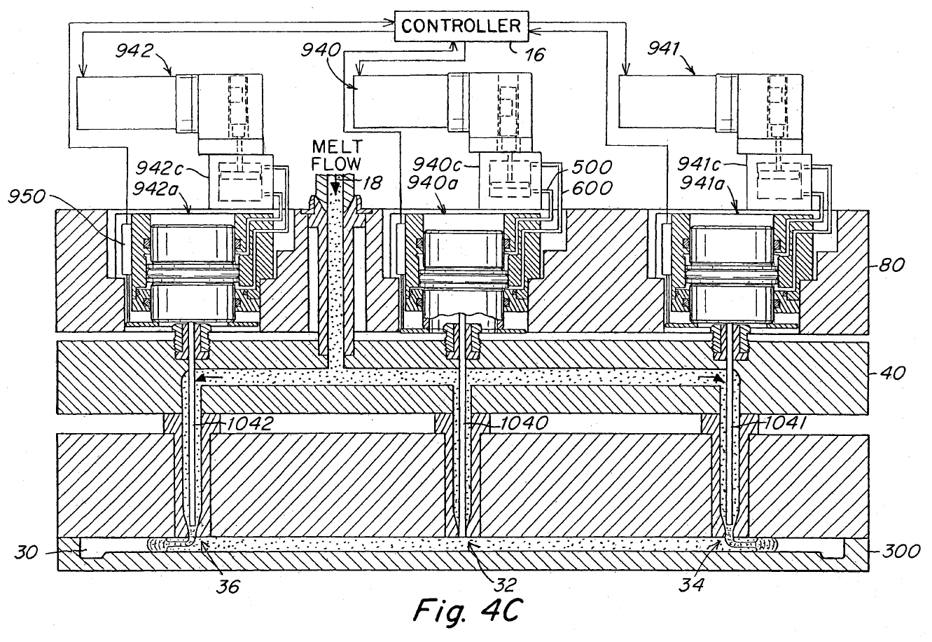

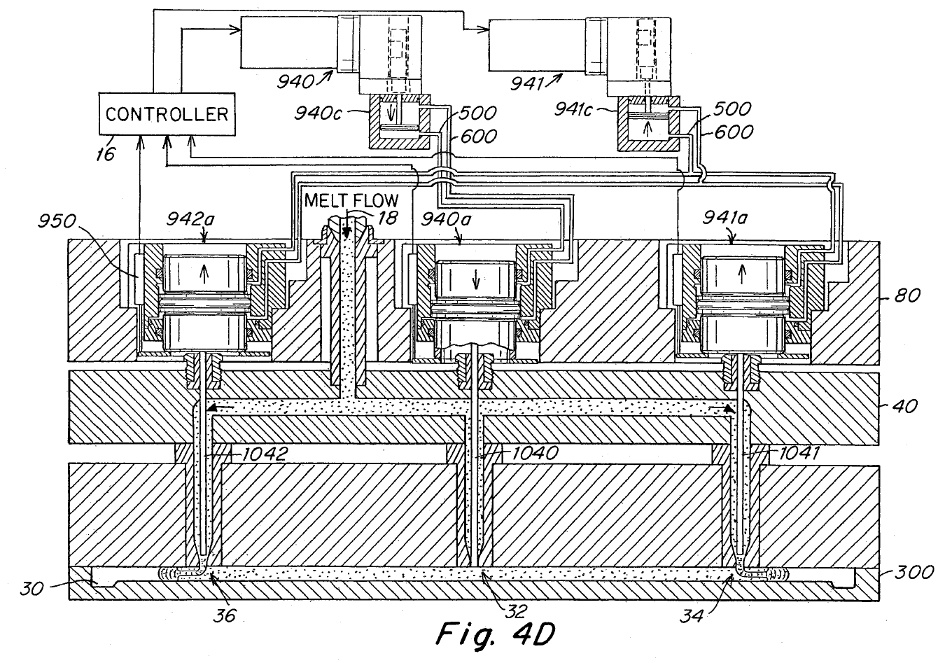

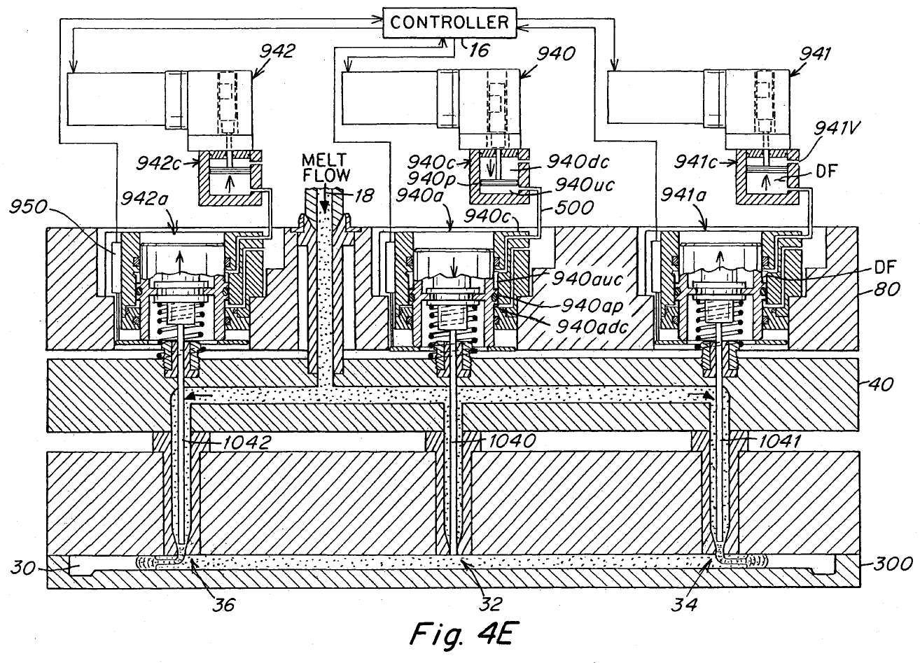

FIGS. 2, 4A, 4B, 4C, 4D, 4E show a system where a rotary driven electric motor or electrically powered rotary actuator (940, 941, 942) drives a first upstream mounted fluid driven actuator cylinder (940c, 941c, 942c) that in turn drives a second downstream fluid driven actuator cylinder (940a, 941a, 942a) which is mounted on, to or in close proximity to a heated manifold 40 or a top clamp plate 80 which is typically cool or cooled relative to the heated manifold 40

The downstream fluid driven actuator 940a, 941a, 942a is drivably interconnected to a valve pin 1040, 1041, 1042 that is arranged to be reciprocally movable along a linear drive axis Y to close and open a gate 32, 34, 36 to a mold cavity 30.

The valve pins 1040, 1041, 1042 are controllably drivable according to a predetermined program to any axial positions intermediate the gate 32, 34, 36 closed and gate open positions. Programmed controllable drive of the electrically powered actuators 940, 941, 942 is typically carried out employing a predetermined algorithm that operates using one or more sensor signals as a variable in the algorithm to control movement of the valve pins beginning from the gate closed position to one or more intermediate positions upstream of gate closed up to a fully gate open position.

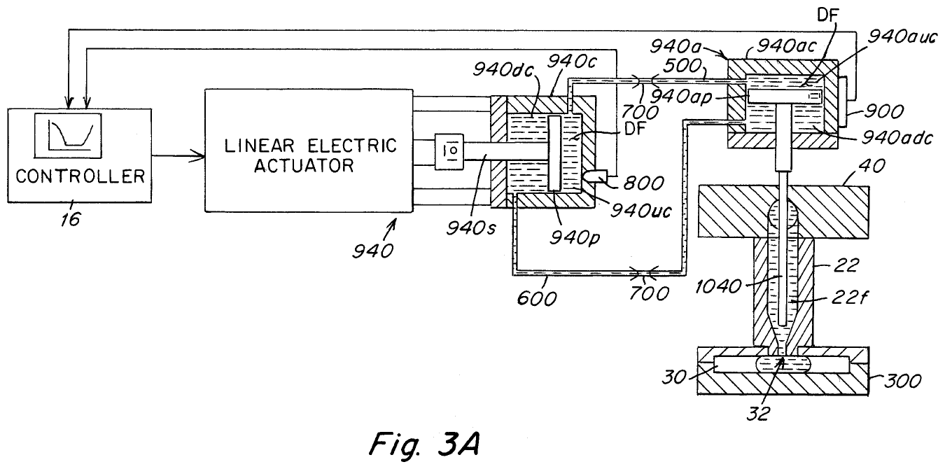

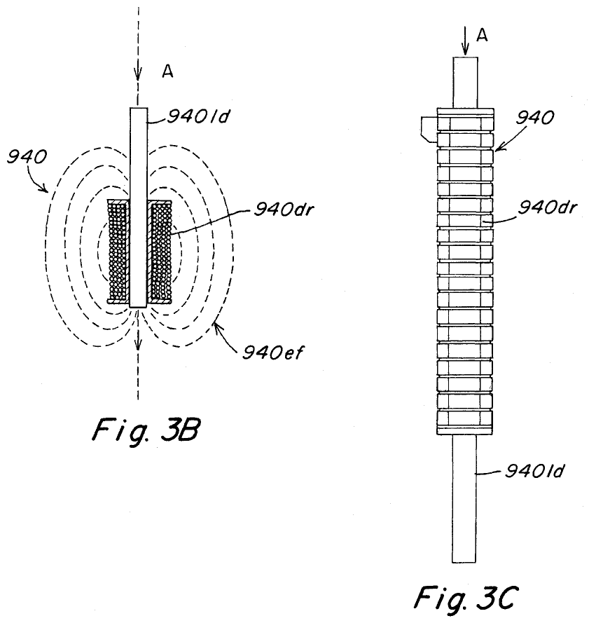

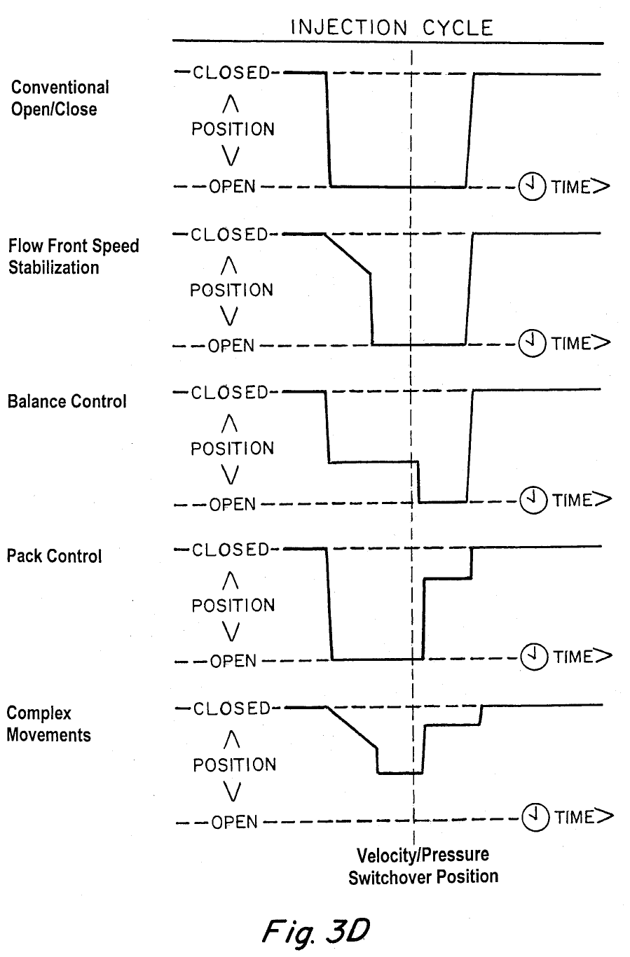

The algorithm and program used to control operation of the electrically powered actuators can employ any one or more of multiple sensor signals as variables to control pin position, pin velocity and pin movement generally. As shown in FIGS. 2, 4A-4E a position sensor 950 and in FIG. 3A a position sensor 900 is shown sending such a control signal to a controller 16. As shown in FIGS. 2, 4A-4E, the position sensor is sensing the position of the piston 940ap, 941ap, 942ap of the downstream actuator. Sensing of the position of the downstream piston 940ap, 941ap, 942ap serves to provide a corresponding precise indication of the position of the valve pin 1040, 1041.

Such a position sensor as sensor 950, FIG. 2 or sensor 900, FIG. 3A can also alternatively or simultaneously be used to detect the position of the upstream piston 940p, 941p, 942p. A Hall Effect Sensor is typically employed for such position sensing of a fluid driven actuator as disclosed in WO 2014/025369 the disclosure of which is incorporated by reference as if fully set forth herein.

A position signal can also be generated and used in the control algorithm by employing a suitable position sensor such as a Hall Effect sensor or a trip sensor as described to detect the position of the driver 940ld of a linear electrically powered actuator as shown in FIGS. 3B, 3C.

A position signal can also be generated and used in the control algorithm by employing a position sensor that senses the rotational position of a rotary electrically powered actuator such as by use of an encoder that detects the rotational position of the rotor of a rotary actuator.

The drive fluid circuit of the FIGS. 2, 4A-4E apparatuses is configured such that drive fluid (oil or gas, hydraulic or pneumatic) is contained within and driven between the upstream and downstream chambers of one of the fluid driven actuator cylinders to the upstream and downstream chambers of the other of the two fluid driven actuator cylinders. Such a closed circuit configuration is preferred over a configuration such as shown in WO2021/019462 A1 where the drive fluid is routed to an external fluid tank and pumped from the tank to and between the drive cylinders 940c, 941c, 942c and 940ac, 941ac, 942ac of the upstream and downstream fluid drive cylinders.

FIG. 3A shows a system similar to FIG. 2 where the electric actuator is a linear actuator and the first fluid driven actuator 940c is provided with a pressure sensor 800 that sends a real time signal indicative of pressure of the drive within the drive chamber of the first fluid driven actuator. A signal indicative of such sensed pressure is sent by the sensor 800 to a controller 16 for use in an algorithm that controls operation of the electrically powered actuator 940. As shown, the downstream second fluid actuator 940a is provided with a position sensor 900 that senses position of the valve pin 1040 or drive piston 940ap and sends a signal indicative of position to the controller that uses such a signal in an algorithm to control drive of the electric actuator 940.

FIG. 3B shows the armature 940dr and driver 940ld or drive rod components of a linear drive proportional solenoid 940 that can be substituted for the use of a rotary electric actuator. As shown in FIG. 3B an electromagnetic field 940ef is generated on supply of electricity to the armature 940dr that acts on the driver 940ld to drive the driver 940ld in a controlled manner reciprocally along a linear path of travel A thus enabling concomintant driven movement of the upstream piston 940p to drive the drive fluid DF (hydraulic or pneumatic) reciprocally back and forth between the interconnected drive chambers of the upstream and downstream fluid actuators which in turn effects controlled reciprocal movement of a valve pin 1040 as shown for example in FIG. 3A.

Similar to the FIG. 3B device, FIG. 3C shows the armature 940dr and driver or drive rod 940ld components of a linear motor that can be mechanically interconnected to the upstream piston 940p in the same manner as the driver 940dr of the FIG. 3B device to effect direct mechanical drive of the upstream piston 940p.

FIG. 3D shows a series of plots of typical examples of valve pin movement versus time during an injection cycle that can be effected using a program that executes instructions that instruct the electrically powered actuator to drive the upstream piston 940p to effect such exemplary movements. As shown in FIG. 3D an algorithm executed by the controller 16 instructs the electrically powered actuator 940 to effect movement of the upstream piston 940p to effect any desired predetermined movements of a valve pin 1040 according to one or the other of the valve pin position or movement profiles shown in FIG. 3D during the course of an injection cycle.

FIG. 4A shows a system comprised of three electric actuators each separately driving an upstream fluid actuator 940c, 941c, 942c. In the FIG. 4A embodiment, the electric actuators 940, 941, 942 and their associated first upstream hydraulic actuators are mounted in a position remote from the subassembly of the top clamp plate, mold and heated manifold 40 of the apparatus in an arrangement such that the electric actuators are isolated from substantial thermal communication with or transmission of heat from the heated manifold 40 to the electric actuators 940, 941, 942. Similarly the first upstream fluid actuators 940c, 941c, 942c are mounted such that they are also isolated from substantial thermal communication with or transmission of heat from the heated manifold 40.

FIG. 4B shows a system according to the invention where the first hydraulic actuator 940c, 941c, 942c is mounted to the top clamp plate via standoffs 941S which are typically comprised of a heat insulative material such as titanium that serve to substantially isolate the electric actuators 940, 941, 942 as well as the first upstream fluid actuators 940c, 941c, 942c from substantial thermal communication with or transmission of heat from the heated manifold 40.

FIG. 4C shows a system configuration where the housing of the first upstream fluid actuators 940c, 941c, 942c is mounted to the top clamp plate 80 of the apparatus. The top clamp plate 80 is typically cool or cooled and where the top clamp plate is disposed between the electric actuators and the heated manifold 40 such that the arrangement substantially isolates the electric actuators 940, 941, 942 as well as the first upstream fluid actuators 940c, 941c, 942c from substantial thermal communication with or transmission of heat from the heated manifold 40.

FIG. 4D shows a configuration where a single first upstream hydraulic actuator 941c is arranged to drive both of a pair of second downstream hydraulic actuators 941a, 942a.

FIG. 4E shows a configuration where the fluid driven actuator cylinders are pneumatic (gas or air) driven and the fluid circuit allows for venting of the gas or air on upstream movement of the piston of the upstream first fluid cylinder 940c via a vent 941V.

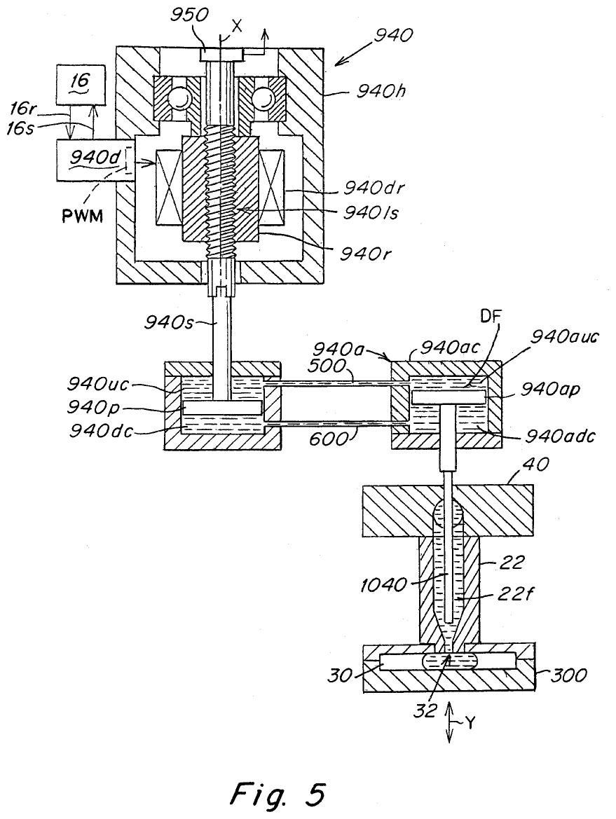

FIG. 5 shows an electric actuator 940 having a drive shaft mechanically interconnected to the piston 940p via a shaft 940s of a first upstream fluid drive cylinder 940. In the embodiment shown the rotor 940r of the electric actuator 940 is coaxially aligned with the linearly driven shaft 9401s of the motor and the drive rod 940s of the piston 940p of the first fluid driven actuator 940c. As shown the downstream second fluid driven cylinder 940a is mounted to the heated manifold 40.

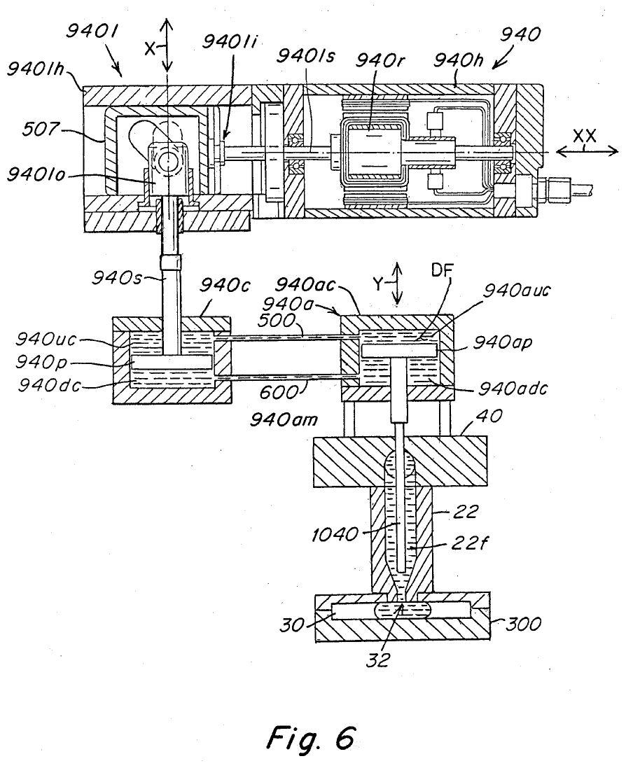

FIG. 6 shows a configuration where the electric actuator 940 has a drive shaft 9401s that is non coaxially arranged relative to the drive shaft of 940s the piston 940p of the first hydraulic actuator 940c and where the downstream second fluid drive cylinder 940a is mounted to the heated manifold 40.

While rotary electric actuators are commonly used, linearly driven actuators or linear actuators can alternatively be used in place of rotary electric actuators. One example of a linear actuator that uses electric energy to directly produce linear motion in instead of rotary motion, is a proportional solenoid as shown in FIG. 3A that effects analog positioning of a. solenoid plunger or rod 940ld, typically a pin driver, as a function of coil current contained in the armature or driver 940dr. Another linear actuator alternative is a solenoid or linear motor, FIG. 3B, that employs a flux carrying geometry that can produce a high starting force on the plunger, pin driver or rod 940ld to cause the plunger, pin driver or rod 940ld to be controllably driven along the linear drive axis A. The resulting force (torque) profile as the solenoid progresses through its operational stroke is nearly flat or descends from a high to a lower value. The solenoid can be useful for positioning, stopping mid-stroke, or for low velocity linear actuation movement of the plunger or rod 940ld, especially in a closed loop control system. The proportional concept is more fully described in SAE publication 860759 (1986) the disclosure of which is incorporated by reference in its entirety as if fully set forth herein.

The linear motor, FIG. 3B, produces a linear force along its drive axis A. A typical mode of operation is as in a Lorentz-type actuator, in which applied force is linearly proportional to applied current and magnetic field. Thus a linear actuator 940, FIGS. 3A, 3B, that effects linear driven movement of a rod, pin driver or plunger or equivalent element 940ld can be employed as an alternative to a rotary driven electric motor for interconnection to a valve pin 50, 1040 to effect controllable driven linear movement of the valve pin 50, 1040, 1041 along its axis X of reciprocal movement as described hereinabove.

A linear actuator is particularly suited for use in a configuration where the drive axis of the actuator and the pin movement axis X are coaxially arranged A linear actuator as described can be used to drive any pin drive member 940ld as an alternative to the rotor based actuators described herein.

FIGS. 7A-7E show a typical injection cycle implementing a cascade process where injection is carried out in a sequence from the center nozzle 22 first and at a later predetermined time from the lateral nozzles 20, 24. As shown in FIG. 7A the injection cycle is started by first opening the pin 1040 of the center nozzle 22 and allowing the fluid material 100 (typically polymer or plastic material) to flow up to a position 100a in the cavity just before 100b the distally disposed entrance into the cavity 34, 36 of the gates of the lateral nozzles 24, 20 as shown in FIG. 7A. After an injection cycle is begun, the gate of the center injection nozzle 22 and pin 1040 is typically left open only for so long as to allow the fluid material 100b to travel to a position 100p just past the positions 34, 36. Once the fluid material has travelled just past 100p of the lateral gate positions 34, 36, the center gate 32 of the center nozzle 22 is typically closed by pin 1040 as shown in FIGS. 7B, 7C, 7D and 7E. The lateral gates 34, 36 are then opened by upstream withdrawal of lateral nozzle pins 1041, 1042 as shown in FIGS. 7B-7E. As described below, the rate of upstream withdrawal or travel velocity of lateral pins 1041, 1042 is controlled as described below.

In alternative embodiments, the center gate 32 and associated actuator 940 and valve pin 1040 can remain open at, during and subsequent to the times that the lateral gates 34, 36 are opened such that fluid material flows into cavity 30 through both the center gate 32 and one or both of the lateral gates 34, 36 simultaneously.

When the lateral gates 34, 36 are opened and fluid material NM is allowed to first enter the mold cavity into the stream 102p that has been injected from center nozzle 22 past gates 34, 36, the two streams NM and 102p mix with each other. If the velocity of the fluid material NM is too high, such as often occurs when the flow velocity of injection fluid material through gates 34, 36 is at maximum, a visible line or defect in the mixing of the two streams 102p and NM will appear in the final cooled molded product at the areas where gates 34, 36 inject into the mold cavity. By injecting NM at a reduced flow rate for a relatively short period of time at the beginning when the gate 34, 36 is first opened and following the time when NM first enters the flow stream 102p, the appearance of a visible line or defect in the final molded product can be reduced or eliminated.

The rate or velocity of upstream withdrawal of pins 1041, 1042 starting from the closed position is controlled via controller 16, FIGS. 2-6 which controls the rate and direction of movement of the second downstream fluid actuator 940a, 941a, 942a.

The position sensors 950 for sensing the position of the actuator pistons and their associated valve pins (such as 1040, 1041, 1042) and feed such position information to controller 16 for monitoring purposes. As shown, fluid material 18 is injected from an injection machine into a manifold runner 19 and further downstream into the bores 44, 46 of the lateral nozzles 24, 22 and ultimately downstream through the gates 32, 34, 36. When the pins 1041, 1042 are withdrawn upstream to a position where the tip end of the pins 1041 are in a fully upstream open position such as shown in FIG. 7D, the rate of flow of fluid material through the gates 34, 36 is at a maximum. However when the pins 1041, 1042 are initially withdrawn beginning from the closed gate position, FIG. 7A, to intermediate upstream positions, FIGS. 7B, 7C, a gap 1154, 1156 that restricts the velocity of fluid material flow is formed between the outer surfaces 1155 of the tip end of the pins 44, 46 and the inner surfaces 1254, 1256 of the gate areas of the nozzles 24, 20. The restricted flow gap 1154, 1156 remains small enough to restrict and reduce the rate of flow of fluid material 1153 through gates 34, 36 to a rate that is less than maximum flow velocity over a travel distance RP of the tip end of the pins 1041, 1042 going from closed to upstream as shown in FIGS. 7A, 7B, 7C, 7E and 8B, 9B.

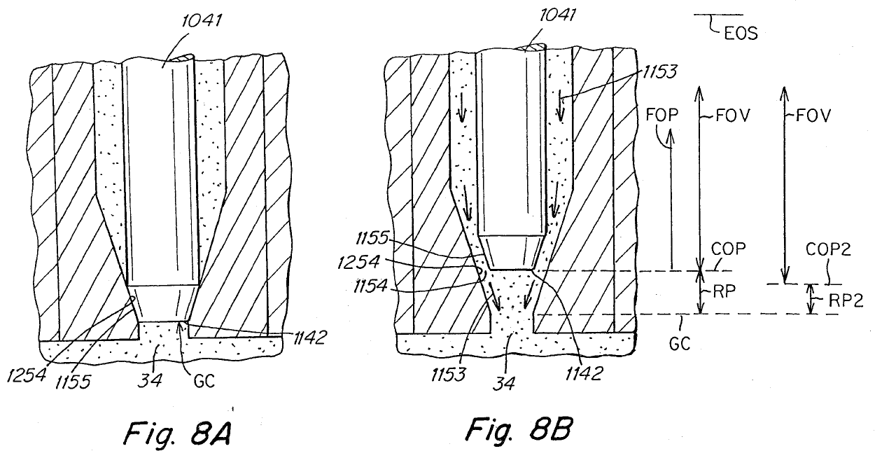

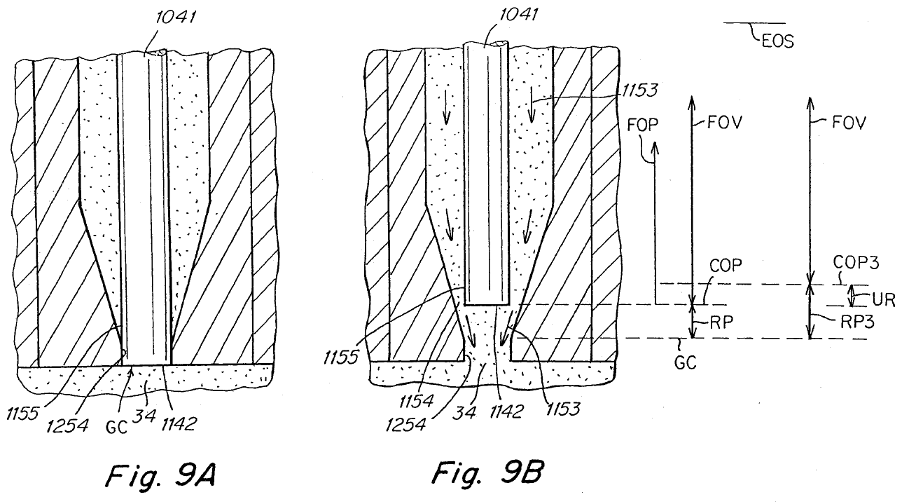

Beginning from a gate closed position, the pins 1040, 1041 can be controllably withdrawn at one or more reduced velocities (less than maximum) for one or more periods of time over the entirety of the length of the path RP over which flow of mold material 1153 is restricted. Preferably the pins are withdrawn at a reduced velocity over more than about 50% of RP and most preferably over more than about 75% of the length RP. As described with reference to FIGS. 8B, 9B, the pins 1041 can be withdrawn at a higher or maximum velocity at the end COP2 of a less than complete restricted mold material flow path RP2. The switch to a higher velocity is preferably triggered by the controller upon detection by a position sensor that the valve pin has reached a preselected intermediate axial position upstream of the gate closed position and downstream of the fully gate open position.

The trace or visible lines that appear in the body of a part that is ultimately formed within the cavity of the mold on cooling above can be reduced or eliminated by reducing or controlling the velocity of the pin 1041, 1042 opening or upstream withdrawal from the gate closed position to a selected intermediate upstream gate open position that is preferably 75% or more of the length of RP.

RP can be about 1-8 mm in length and more typically about 2-6 mm and even more typically 2-4 mm in length. As shown in FIG. 2 in such an embodiment, a control system or controller 16 is preprogrammed to control the sequence and the rates of valve pin 1040, 1041, 1042 opening and closing. The controller 16 controls the rate of travel, namely velocity of upstream travel, of a valve pin 1041, 1042 from its gate closed position for at least the predetermined amount of time that is selected to withdraw the pin at the selected reduced velocity rate.

As used in this application with regard to various monitoring and control systems, the terms “controller,” “component,” “computer” and the like are intended to refer to a computer-related entity, either hardware, a combination of hardware and software, software, or software in execution. For example, a component or controller may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Claimed methods of the present invention may also be illustrated as a flow chart of a process of the invention. While, for the purposes of simplicity of explanation, the one or more methodologies shown in the form of a flow chart are described as a series of acts, it is to be understood and appreciated that the present invention is not limited by the order of acts, as some acts may, in accordance with the present invention, occur in a different order and/or concurrent with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

In various embodiments of the invention disclosed herein, the term “data” or the like means any sequence of symbols (typically denoted “0” and “1”) that can be input into a computer, stored and processed there, or transmitted to another computer. As used herein, data includes metadata, a description of other data. Data written to storage may be data elements of the same size, or data elements of variable sizes. Some examples of data include information, program code, program state, program data, other data, and the like.

As used herein, computer storage media or the like includes both volatile and nonvolatile, removable and non-removable media for storage of information such as computer-readable instructions, data structures, program modules, or other data. Computer storage media includes RAM, ROM, EEPROM, FLASH memory or other memory technology, CD-ROM, digital versatile disc (DVDs) or other optical disk storage, magnetic cassettes, magnetic tape, magnetic disk storage or other magnetic storage devices, or any other medium which can be used to store desired information and which can be accessed by the computer.

The methods described herein may be implemented in a suitable computing and storage environment, e.g., in the context of computer-executable instructions that may run on one or more processors, microcontrollers or other computers. In a distributed computing environment (for example) certain tasks are performed by remote processing devices that are linked through a communications network and program modules may be located in both local and remote memory storage devices. The communications network may include a global area network, e.g., the Internet, a local area network, a wide area network or other computer network. It will be appreciated that the network connections described herein are exemplary and other means of establishing communications between the computers may be used.

A computer may include one or more processors and memory, e.g., a processing unit, a system memory, and system bus, wherein the system bus couples the system components including, but not limited to, the system memory and the processing unit. A computer may further include disk drives and interfaces to external components. A variety of computer-readable media can be accessed by the computer and includes both volatile and nonvolatile media, removable and nonremovable media. A computer may include various user interface devices including a display screen, touch screen, keyboard or mouse.

A “controller,” as used herein also refers to electrical and electronic control apparatus that comprise a single box or multiple boxes (typically interconnected and communicating with each other) that contain(s) all of the separate electronic processing, memory and electrical signal generating components that are necessary or desirable for carrying out and constructing the methods, functions and apparatuses described herein. Such electronic and electrical components include programs, microprocessors, computers, PID controllers, voltage regulators, current regulators, circuit boards, motors, batteries and instructions for controlling any variable element discussed herein such as length of time, degree of electrical signal output and the like. For example a component of a controller, as that term is used herein, includes programs, controllers and the like that perform functions such as monitoring, alerting and initiating an injection molding cycle including a control device that is used as a standalone device for performing conventional functions such as signaling and instructing an individual injection valve or a series of interdependent valves to start an injection, namely move an actuator and associated valve pin from a gate closed to a gate open position. In addition, although fluid driven actuators are employed in typical or preferred embodiments of the invention, actuators powered by an electric or electronic motor or drive source can alternatively be used as the actuator component.

The actuator controller 16 typically includes additional instructions that can instruct a valve pin 1041, 1042, 1040 to be driven either upstream or downstream starting from either a fully closed downstream or a fully upstream, gate open position at one or more reduced upstream or reduced downstream velocities over at least the beginning portion of the upstream path of travel of the valve pins 1040, 1041, 1042 or the latter portion of the downstream path of travel of the valve pins toward the gates 32, 34, 36 where the tip end 1142 of the pin 1041 restricts flow of the injection fluid through the gate RP, RP2, RP3 such as shown in FIGS. 8A, 8B, 9A, 9B. Reduced upstream velocity (beginning from the closed position) or reduced downstream velocity (typically occurring at the end of the downstream length of the downstream stroke) of a valve pin 1041, FIGS. 8A, 8B, 9A, 9B can serve to lessen the degree of downward flow of injection fluid at the beginning of a cycle or downward force DF, FIGS. 8B, 9B, exerted by the tip end 1142 of the pin on the injection fluid 1153f, FIGS. 8B, 9B, that is forcibly pushed through the gate and into the cavity 1153c, FIGS. 8A, 9A, when the tip end of the valve pin travels downstream to a position where the tip end closes the gate, FIGS. 8A, 9A. Such reduced force DF exerted on the injection fluid 1153g at the very beginning or end portion of travel RP, RP2 of the injection cycle at or near the entrance 34 to the cavity of the mold thus reduces the likelihood of a blemish or artifact being formed on the part that is formed within the cavity at the gate area 34. Preferably, when the valve pin 1041 is withdrawn from a gate closed position at a reduced velocity, the valve pin 1041 is subsequently withdrawn at a higher velocity (typically maximum velocity) when the valve pin is detected by a position sensor to have reached a predetermined axial position upstream of the gate closed position. Once the valve pin 1041 has been detected to have reached the predetermined upstream position, the valve pin is typically withdrawn all the way to a fully gate open position at the higher velocity.

In one embodiment, the valve pin is driven along the axis FIGS. 8A, 9A, of the valve pin and drives the tip end 1142 of the valve pin between a first position where the tip end of the valve pin obstructs the gate 34 to prevent the injection fluid from flowing into the cavity, a second position, FIGS. 8B, 9B upstream of the first position RP, RP2, RP3 wherein the tip end 1142 of the valve pin restricts flow 1153 of the injection fluid along at least a portion of the length of the drive path extending between the first position and the second position, and a third maximum upstream position FOP where the injection fluid material flows freely without restriction from the tip end 1142 of the pin through the first gate.

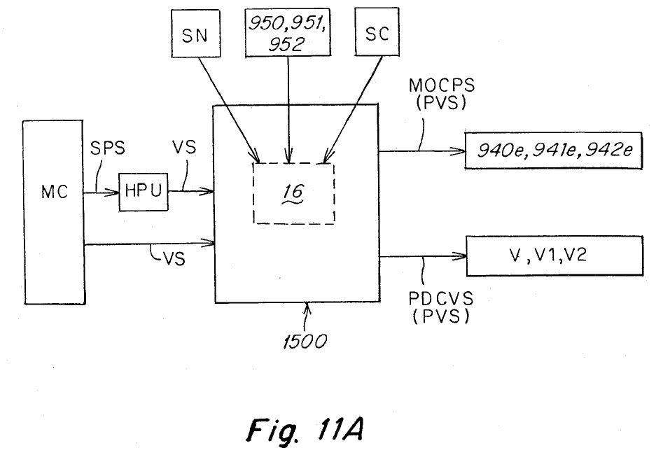

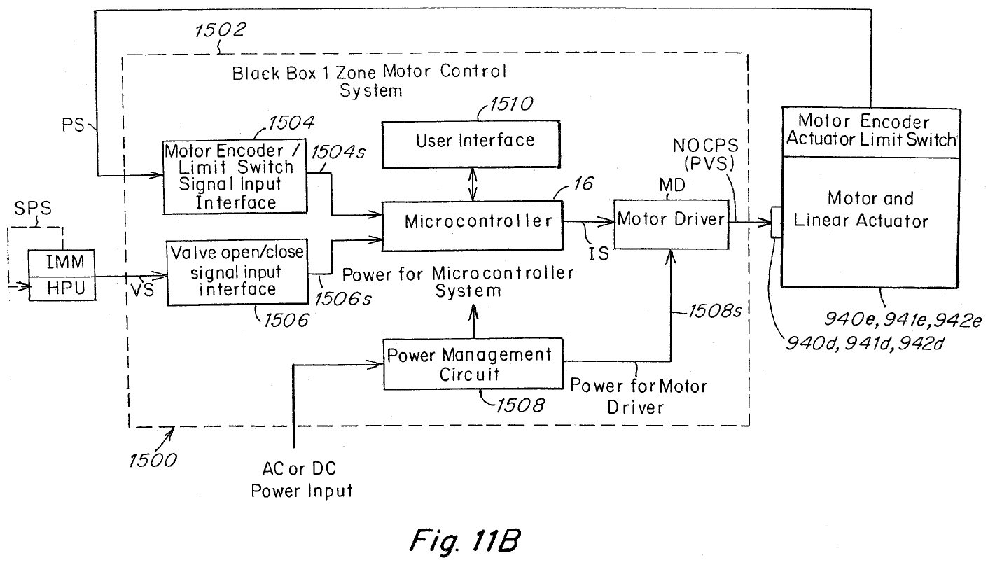

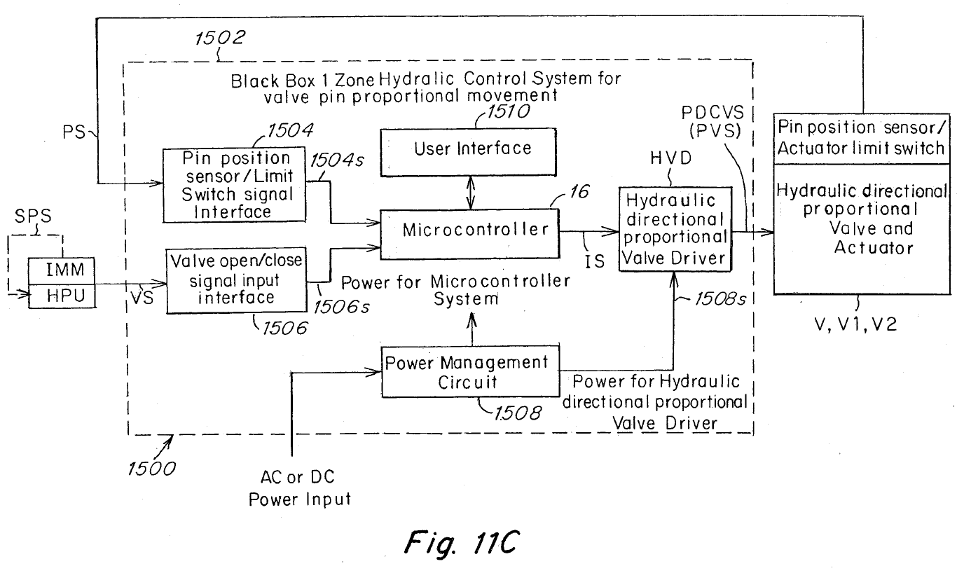

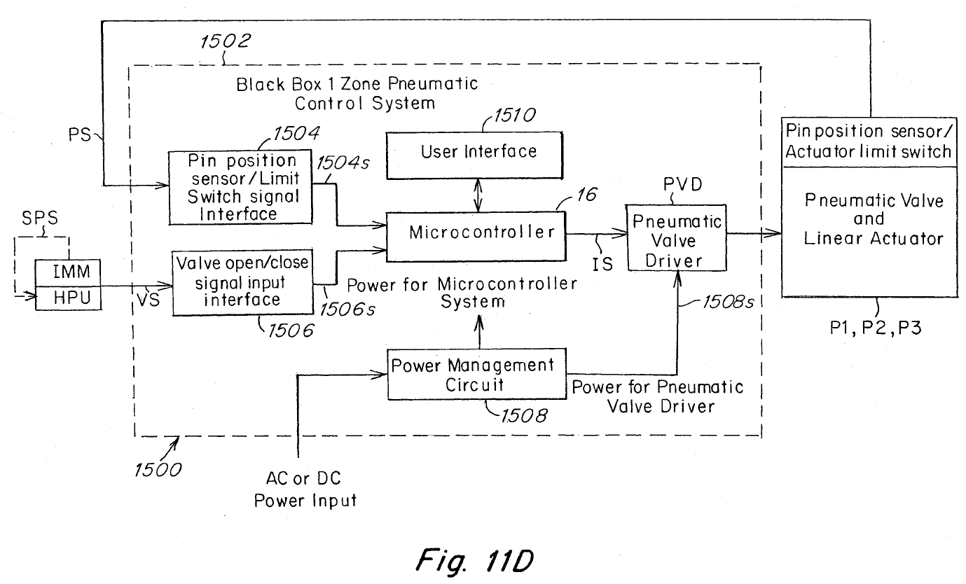

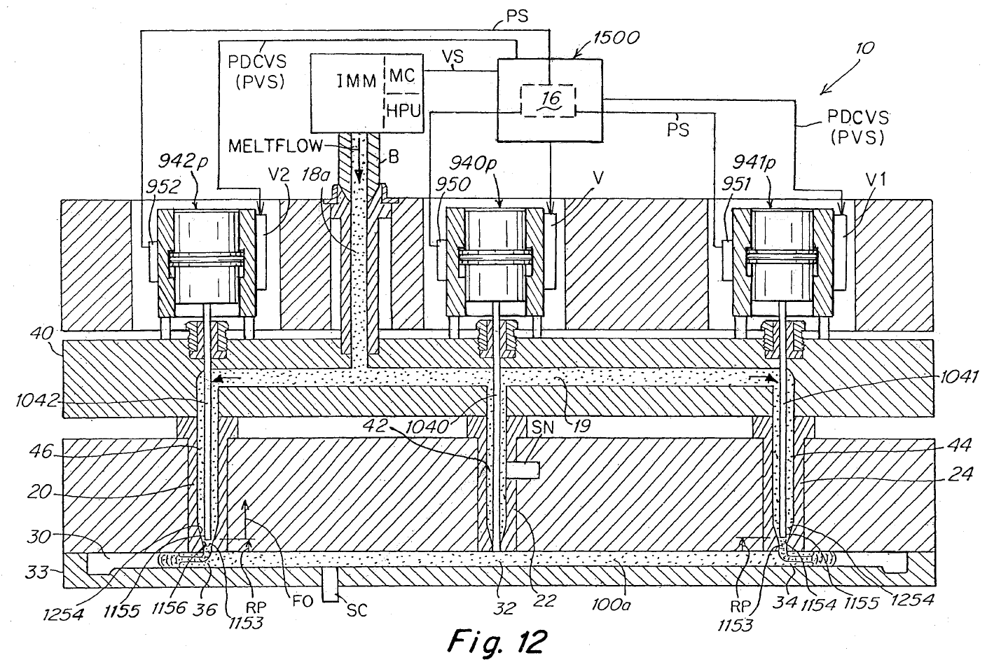

In an embodiment such as shown in FIGS. 11, 12 an injection cycle can be started by first opening the pin 1040 of the center nozzle 22, and allowing the fluid material 100a (typically polymer or plastic material) to flow up to a position the cavity just before 100b the distally disposed entrance into the cavity 34, 36 of the gates of the lateral nozzles 24, 20. After an injection cycle is begun, the gate of the center injection nozzle 22 and pin 1040 is typically left open only for so long as to allow the fluid material 100b to travel to a position just past 100p the positions 34, 36. Once the fluid material has travelled just past 100p the lateral gate positions 34, 36, the center gate 32 of the center nozzle 22 is typically closed by pin 1040. The lateral gates 34, 36 are then opened by upstream withdrawal of lateral nozzle pins 1041, 1042. As described below, the rate of upstream withdrawal or travel velocity of lateral pins 1041, 1042 is controlled as described herein.

In alternative embodiments, the center gate 32 and associated actuator 940e, 940p and valve pin 1040 can remain open at, during and subsequent to the times that the lateral gates 34, 36 are opened such that fluid material flows into cavity 30 through both the center gate 32 and one or both of the lateral gates 34, 36 simultaneously. When the lateral gates 34, 36 are opened and fluid material NM is allowed to first enter the mold cavity into the stream 102p that has been injected from center nozzle 22 past gates 34, 36, the two streams NM and 102p mix with each other. If the velocity of the fluid material NM is too high, such as often occurs when the flow velocity of injection fluid material through gates 34, 36 is at maximum, a visible line or defect in the mixing of the two streams 102p and NM will appear in the final cooled molded product at the areas where gates 34, 36 inject into the mold cavity. By injecting NM at a reduced flow rate for a relatively short period of time at the beginning when the gate 34, 36 is first opened and following the time when NM first enters the flow stream 102p, the appearance of a visible line or defect in the final molded product can be reduced or eliminated.

In a conventional system, the injection molding machine IMM includes its own internal manufacturer supplied machine controller that generates standardized beginning of cycle gate closed and end of cycle gate open and gate closed machine voltage signals VS typically 0 volts for gate open and 24 volts for gate open (or 0 volts and 120 volts respectively). The standardized machine voltage signals VS are typically sent either directly to the solenoids of a master directional control valve 12 (that controls the direction of flow of actuator drive fluid into or out of the drive chambers of all of the plurality of fluid driven actuators 940f, 941f, 9420 to cause the directional control valve 12 (DCV) to move to a gate closed or gate open actuator drive fluid flow position. Or, the same standardized voltage signals VSC can be sent to the directional control valve 12 via the actuator controller 16 which generates the same standardized voltage signals VSC as the VS signals in response to receipt from a screw position sensor SPSR of a machine screw position signal SPS sent by the injection molding machine IMM to the actuator controller 16, the actuator controller 16 thus generating the same beginning of cycle and end of cycle control voltage signals VSC as the machine IMM can otherwise generate and send VS directly to the directional control valve 12. Thus, where conventional standardized directional control valves 12 are used, the sending of start of cycle and end of cycle signals can be simplified via electrical or electronic signal connections directly to the internal signal generator or controller contained within the injection molding machine.

Electrically powered actuators or electric motors and proportional directional control valves cannot directly receive and utilize a standardized 0 volt (gate closed), 24 volt (gate open) or 0 volt (gate closed) 120 volt (gate open) signals generated by the start and stop cycle controller or signal generator that is typically included in a conventional injection molding machine.

As shown in a generic schematic form in FIG. 11A, a system 10 according to the invention incorporates a signal converter 1500 that can receives standardized injection machine generated start of cycle and end of cycle signals VS (such as 0 volts, 24 volts or 120 volts) and converts the received standardized signal VS to an output power signal MOCPS or PDCVS that is compatible for receipt and use by an electric motor or a proportional direction control valve power signal. The two different actuator based systems, namely electric motor and proportional directional control valve, are shown together in the generic FIG. 11A for illustration purposes only. More typically, a practical implementation of a system as shown in FIG. 11A would be such that the converter 1500 would contain a single microcontroller and an interconnected driver that is configured to work with one or the other of an electric actuator based system or a proportional directional control valve system.

FIG. 11 shows an electric actuator based system in simplified schematic form. As shown in FIG. 11, electric actuators 940e, 941e, 942e each have a rotating rotor 940r, 941r, 942r that is driven by electrical power (typically delivered via the converter 1500) one or more of the precise polarity, amplitude, voltage and strength of which is controlled for input to the motors by actuator controller 16 and the program contained in the actuator controller 16. The rotating rotors 940r, 941r, 942r are interconnected to a translationally movable shaft or other suitable connecting devices 940c, 941c, 942c that interconnect the valve pins 1040, 1041, 1042 to the driven rotors 940r, 941r, 942r. A typical interconnection between a shaft driven by a rotor and the head of a valve pin is shown in U.S. Reexamination Certificate 6,294,122 C1 and U.S. Pat. No. 9,492,960 the disclosures of which are incorporated herein by reference in their entirety as if fully set forth herein.

FIG. 11 illustrates an example of a conventional system 10 according to the invention having a plurality of electric power driven actuators 940e, 941e, 942e, with a central nozzle 22 feeding molten material 18 from an injection molding machine IMM through a main inlet 18a from a barrel of the injection molding machine IMM to a distribution channel 19 of a manifold 40.

In an alternative embodiment, the electric actuators 940e, 941e, 942e can be mounted remote from the manifold 40 and mechanically interconnected to a first upstream fluid cylinder 940c, 941c, 942c which is coupled to a second downstream fluid actuator 940a, 941a, 942a in the same manner as described above with respect to the FIGS. 2-6 embodiments to drive a configuration of upstream and downstream fluid actuators that drive a valve pin in the same manner as described above with respect to the FIGS. 2-6 embodiments.

In the FIGS. 11, 12 system as shown, the IMM typically comprises a barrel (not shown) and a controllably rotatably drivable or driven screw BS disposed within the barrel to generate a pressurized supply of injection fluid 18 the pressure of which can be detected by a barrel pressure sensor BPSR which can send a signal indicative of barrel pressure to a controller 16 for use in controlling positioning and velocity of the valve pin 1040, 1041, 1042. The screw BS of the IMM initiates and ends an injection cycle at selected points in time when rotation of the screw BS is started and stopped. The beginning of an injection cycle is typically defined at a first selected point in time when the screw BS is initially rotated from a standstill position or at a time that occurs shortly after the time when the screw is initially rotated. The end of the cycle is typically defined by a selected second time following and after the first selected time at which second time the screw is stopped from rotating and injection fluid 18 is stopped from being injected into the heated manifold 40.

The distribution channel 19 commonly feeds three separate nozzles 20, 22, 24 which all commonly feed into a common cavity 30 of a mold 33. The nozzle 22, 24, 26 as shown can be controlled upstream by a configuration of an electric motor actuator 940e mechanically interconnected to a first upstream fluid actuator 940c and downstream actuator 940a as described above regarding the FIGS. 2-6 embodiments.

As shown in the FIG. 11 embodiment, a pair of lateral nozzles 20, 24 feed into the cavity 30 at gate locations that are distal 34, 36 to the center gate feed position 32. As with a conventional system, an injection cycle using the systems of FIGS. 11, 12 are typically used to carry out a cascade or sequential valve gate process where injection is effected in a sequence from the center nozzle 22 first and at later predetermined times from the lateral nozzles 20, 24. The cascade process is discussed in detail as an example only, the invention encompassing configurations and protocols where a single valve pin and valve gate inject into a single cavity.

Also as with a conventional system, the FIGS. 11, 12 systems 10 include an actuator controller 16 that typically includes a program that converts a standard voltage signal (such as 0V, 24V, 120V) received from an injection machine controller MC into an instruction signal IS that is compatible with, receivable and interpretable by a motor driver MD to cause the motor driver MD to generate a motor operating control power signal MOCPS that signals the start of an injection cycle and the end of injection cycle, the start typically being a power signal that drives the motor to withdraw the valve pin 1040, 1041, 1042 from a gate closed position and the end being a power signal that drives the motor to drive the valve pin from an upstream position to a gate closed position. The controller 16 can include a program with instructions that can move and drive the valve pin to and along any predetermined position or velocity profile including at reduced velocities as described above. Reduced velocity in the case of the FIG. 2 system means a velocity that is less than the maximum velocity at which the electric actuator is capable of driving the pin, typically less than about 75% of maximum and more typically less than about 50% of maximum velocity whether upstream or downstream.

A signal converter 1500, FIGS. 11, 11A, 11B, 11C, 11D, 12 can be provided that enables a user to connect the standardized voltage signal output (VS, VSC) of a conventional IMM controller to the input of the electric motors 940e, 941e, 942e, FIGS. 2, 3 in the same manner that the user interconnected an IMM controller in a conventional system as in FIG. 1 to DCVs. The signal converter 1500 of the FIGS. 2, 3 systems receives and converts received IMM voltage signals (such as 0 volts, 24 volts, 120 volts) to control signals (MOCPS or PDCVS that operate to begin cycle and end cycle). As shown in FIGS. 2, 2A, 3 the standardized voltage signals VS can be alternatively generated by an HPU (hydraulic power unit) that is physically separate but interconnected to the machine controller MC, the HPU unit, FIGS. 11, 11A, 11B, 11C, 3 receiving a barrel screw position signal SPS from the machine controller and generating therefrom a corresponding standardized VS signal that is in turn sent to the controller 16 for conversion to an instruction signal IS usable by either a motor driver MD, FIG. 11, or by a proportional directional valve driver HVD, PVD to drive either a motor or a proportional directional valve to initiate and end an injection cycle.

Thus the standard start and stop control signals generated by an IMM (VS, VSC) can operate in conjunction with the converter 1500 to instruct either the electric actuators, 940e, 941e, 942e to at least initiate or begin an injection cycle (such as by instructing the actuators 940e, 941e, 942e to drive a valve pin upstream from a gate closed position) and to end or stop an injection cycle (such as by instructing the actuators 940e, 941e, 942e, 940p, 941p, 942p to drive a valve pin downstream from a gate open position into a gate closed position).

The FIG. 12 embodiment is shown for background in explanation of the use and conversion of IMM signals (VS, VSC) by the signal conversion device 1500 that are usable by the electrically powered actuators 940c, 941c, 942c as described with reference to the configurations shown and described with reference to FIGS. 2-6.

Most preferably the physical or mechanical electric signal connectors that are typically used to connect a wire or cable from the IMM (or machine controller MC) to the signal conversion device 1500, are the same physical or mechanical connectors that are used in conventional systems to connect the IMM (or machine controller MC) to the DCVs of a conventional system as described with reference to FIG. 1.

As shown in FIGS. 11, 11A, 11B, 11C, 11D, 12 the signal output VS of the IMM can be connected directly to signal converter 1500 which converts the VS signal into a motor open close power signal MOPCS or a proportional directional control valve signal PDCVS that is compatible with and processable by the motors 940e, 941e, 942e or the proportional directional control valves V, V1, V2. Alternatively, the signal output of the IMM of the machine controller MC of the FIG. 11 embodiment can comprise a barrel screw position signal SPS that is sent to an intermediate HPU unit by a screw position sensor SPSR.

The MOCPS and PDCVS signals include signals that correspond to the VS signals that operate to affect the beginning and end of an injection cycle.

Typically the FIG. 11, 12 system 10 includes one or more position sensors, 950, 951, 952 or other sensors, SN, SC that detect a selected condition of the injection fluid 18 in one or more of the manifold fluid flow channel 19, a nozzle flow channel 42, 44, 46 or in the cavity 30 of the mold 33.

The actuator controller 16 can include a program that receives and processes a real time signal indicative of a condition of the injection fluid 18 or a component of the apparatus (10) such as rotational position of a rotor 940r, 941r, 942r or axial linear position of a valve pin 1040, 1041, 1042. The real time signals sent to and received by the actuator controller 16 are generated by one or more of position sensors 950, 951, 952 or fluid condition sensors SN, SC. The sensors detect and send a signal to the actuator controller that is typically indicative of one or more of rotational position (sensors 950, 951, 952) of a rotor 940r, 941r, 942r or of linear axial position of a valve pin 1040, 1041, 1042. The fluid condition sensors typically comprise one or more of a pressure or temperature sensor SN that senses injection fluid 18 within a manifold channel 19 or a nozzle channel 42, 44, 46 or senses pressure or temperature of the injection fluid SC within the cavity 30 of the mold 33.

The actuator controller 16 can include a program that processes the received signal(s) from one or more of the sensors 950, 951, 952, SN, SC according to a set of instructions that use the received signals as a variable input or other basis for controlling one or more of the position or velocity of the actuators 940e, 941e, 942e or their associated valve pins 1040, 1041, 1042 throughout all or selected portion of the duration of an injection cycle or all or a portion of the length of the upstream or downstream stroke of the actuators 940e, 941e, 942e.

As shown the controller 16 can be included within and comprise a component of the converter 1500. Where the converter 1500 includes a controller 16 that includes position and velocity control instructions, the converter 1500 can thus send its machine open close power signals MOCPS (or valve open close signals PDCVS) together with position velocity signals (PVS) to either the electric actuators 940e, 941e, 942e or proportional directional control valves V, V1, V2. The control signals MOCPS and PDCVS thus include a signal that has been converted from and corresponds to one or the other of the converted VS signals received by the converter 1500 from the IMM controller MC or the HPU. The position or velocity control signals PVS can control the position or velocity of the valve pin according to any predetermined profile of pin position or velocity versus time of injection cycle. The form, format, intensity and frequency of the MOCPS, PDCVS and PVS signals are compatible with the signal receiving interface of the electric actuators 940e, 941e, 942e or valves V, V1, V2.

User Interface and Target Profiles

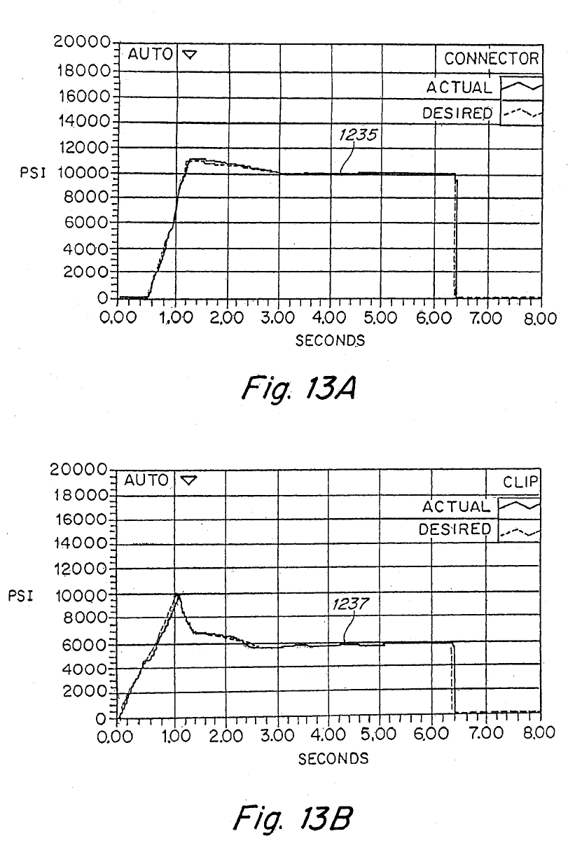

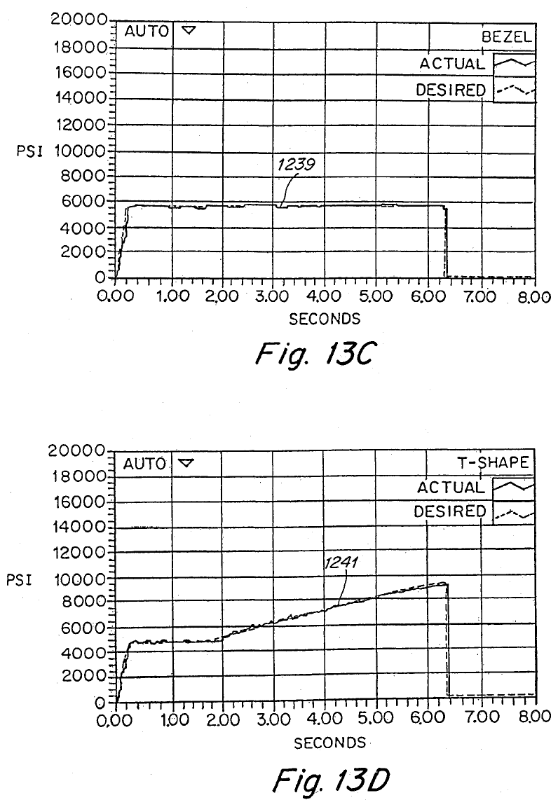

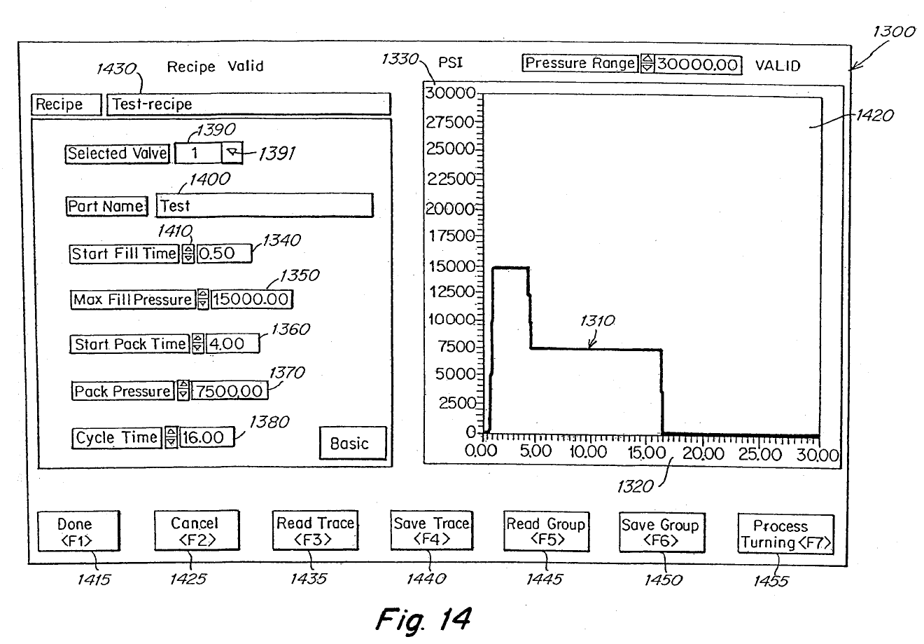

FIGS. 13A-13D, 14 show time versus pressure graphs (1235, 1237, 1239, 1241, 1310) of the pressure detected by four pressure transducers associated with and measuring the injection fluid pressure flowing through four nozzles mounted in a manifold block. The four nozzles can be configured as shown in FIG. 10 and include pressure transducers coupled to the controller 16 that controls movement of the electric actuators that drive the first upstream fluid driven actuator 940c, 941c, 942c.

The graphs of FIGS. 13A-13D are generated on a user interface (e.g., 21, 71 of FIG. 1), so that a user can observe the tracking of the actual pressure versus the target pressure during the injection cycle in real time, or after the cycle is complete. The four different graphs of FIG. 9 show four independent target pressure profiles (“desired”) emulated by the four individual nozzles. Different target profiles are desirable to uniformly fill different sized individual cavities associated with each nozzle, or to uniformly fill different sized sections of a single cavity. Graphs such as these can be generated with respect to any of the previous embodiments described herein.

The valve pin associated with graph 1235 is opened sequentially at 0.5 seconds after the valves associated with the other three graphs (1237, 1239 and 1241) were opened at 0.00 seconds. At approximately 6.25 seconds, at the end of the injection cycle, all four valve pins are back in the closed position. During injection (for example, 0.00 to 1.0 seconds in FIG. 9B) and pack (for example, 1.0 to 6.25 seconds in FIG. 9B) portions of the graphs, each valve pin is controlled to a plurality of positions to alter the pressure sensed by the pressure transducer associated therewith to track the target pressure.

Through the user interface, target profiles can be designed, and changes can be made to any of the target profiles using standard (e.g., windows-based) editing techniques. The profiles are then used by controller 1016 to control the position of the valve pin. For example, FIG. 14 shows an example of a profile creation and editing screen 1300 generated on a user interface.

Screen 1300 is generated by a windows-based application performed on the user interface, e.g., any of the user interfaces 21 shown in FIG. 1. Alternatively, this screen display could be generated on an interface associated with the controller (e.g., display 71 associated with controller 8 in FIG. 1). Interactive screen 1300 provides a user with the ability to create a new target profile or edit an existing target profile for any given nozzle and cavity associated therewith.

A profile 1310 includes (x, y) data pairs, corresponding to time values 1320 and pressure values 1330 which represent the desired pressure sensed by the pressure transducer for the particular nozzle being profiled. The screen shown in FIG. 14 is shown in a “basic” mode in which a limited group of parameters are entered to generate a profile. For example, in the foregoing embodiment, the “basic” mode permits a user to input start time displayed at 1340, maximum fill pressure displayed at 1350 (also known as injection pressure), the start of pack time displayed at 1360, the pack pressure displayed at 1370, and the total cycle time displayed at 1380.

The screen also allows the user to select the particular valve pin they are controlling displayed at 1390, and name the part being molded displayed at 1400. Each of these parameters can be adjusted independently using standard windows-based editing techniques such as using a cursor to actuate up/down arrows 1410, or by simply typing in values on a keyboard. As these parameters are entered and modified, the profile will be displayed on a graph 1420 according to the parameters selected at that time.

By clicking on a pull-down menu arrow 1391, the user can select different nozzle valves in order to create, view or edit a profile for the selected nozzle valve and cavity associated therewith. Also, a part name 1400 can be entered and displayed for each selected nozzle valve.

The newly edited profile can be saved in computer memory individually, or saved as a group of profiles for a group of nozzles that inject into a particular single or multi-cavity mold. The term “recipe” is used to describe one or more of profiles for a particular mold and the name of the particular recipe is displayed at 1430 on the screen icon.

To create a new profile or edit an existing profile, first the user selects a particular nozzle valve of the group of valves for the particular recipe group being profiled. The valve selection is displayed at 1390. The user inputs an alpha/numeric name to be associated with the profile being created, for family tool molds this may be called a part name displayed at 1400. The user then inputs a time displayed at 1340 to specify when injection starts. A delay can be with particular valve pins to sequence the opening of the valve pins and the injection of melt material into different gates of a mold.

The user then inputs the fill (injection) pressure displayed at 1350. In the basic mode, the ramp from zero pressure to max fill pressure is a fixed time, for example, 0.3 seconds. The user next inputs the start pack time to indicate when the pack phase of the injection cycle starts. The ramp from the filling phase to the packing phase is also fixed time in the basic mode, for example, 0.3 seconds.

The final parameter is the cycle time which is displayed at 1380 in which the user specifies when the pack phase (and the injection cycle) ends. The ramp from the pack phase to zero pressure may be instantaneous when a valve pin is used to close the gate, or slower in a thermal gate due to the residual pressure in the cavity which will decay to zero pressure once the part solidifies in the mold cavity.

User input buttons 1415 through 1455 are used to save and load target profiles. Button 1415 permits the user to close the screen. When this button is clicked, the current group of profiles will take effect for the recipe being profiled. Cancel button 1425 is used to ignore current profile changes and revert back to the original profiles and close the screen. Read Trace button 1435 is used to load an existing and saved target profile from memory. The profiles can be stored in memory contained in one or more of the operator interface 21, the main MCU 9, and the recipe storage MCU 16. Save trace button 1440 is used to save the current profile. Read group button 1445 is used to load an existing recipe group. Save group button 1450 is used to save the current group of target profiles for a group of nozzle valve pins. The process tuning button 1455 allows the user to change the settings (for example, the gains) for a particular nozzle valve in a control zone. Also displayed is a pressure range 1465 for the injection molding application.

What is claimed is:

1. An injection molding apparatus, comprising:
an injection molding machine adapted to inject a flow of injection fluid to a heated manifold, the heated manifold adapted to distribute the injection fluid to a flow channel that is adapted to deliver the injection fluid to a gate of a mold cavity;
a first fluid drive cylinder having a first piston disposed within the first fluid drive cylinder adapted to be driven reciprocally upstream and downstream within the first fluid drive cylinder;
a second fluid drive cylinder having a second piston disposed within the second fluid drive cylinder and interconnected to a valve pin
wherein the first fluid drive cylinder and the second fluid drive cylinder are interconnected in an arrangement wherein reciprocating movement of the first piston drives concomitant back and forth movement of the second piston and concomitant back and forth movement of the valve pin along a selected path of travel (Y) within the flow channel between gate closed and gate open positions;
an electrically powered actuator adapted to drive the first piston reciprocally within the first fluid drive cylinder according to a drive program that instructs the electrically powered actuator to drive the valve pin between the gate closed and gate open positions and one or more selected positions therebetween.

2. An apparatus according to claim 1 wherein the electrically powered actuator is the sole source of drive force on the first piston.

3. An apparatus according to claim 1 wherein the first fluid drive cylinder and the second fluid drive cylinder are drivably interconnected in a closed fluid circuit arrangement.

4. Apparatus of claim 1 wherein the electrically powered actuator is mounted in a position remote from the heated manifold.

5. Apparatus of claim 1 wherein the electrically powered actuator is mounted such that the electrically powered actuator is isolated from substantial communication of heat with the heated manifold.

6. Apparatus of claim 1 wherein the first fluid drive cylinder and the second fluid drive cylinder are interconnected via fluid sealed conduit that enables drive fluid to flow directly between the first fluid drive cylinder and the second fluid drive cylinder, the fluid sealed conduit including one or more connectors adapted to enable the conduit interconnection between the first fluid drive cylinder and the second fluid drive cylinder to be readily disconnected and readily connected.

7. Apparatus of claim 1 wherein the electrically powered actuator comprises either a linear actuator or a rotatable actuator having a driver arranged to drive the first piston reciprocally upstream and downstream within the first fluid drive cylinder.

8. Apparatus of claim 7 wherein the electrically powered actuator includes a linear travel converter adapted to drive the first piston along a selected linear converter path of travel (XX) that is non-coaxial with an axis (X) of the driver.

9. The apparatus of claim 1 further comprising a controller and one or more of:
(i) a pressure sensor adapted to sense pressure of drive fluid (DF) disposed within a fluid drive cylinder and generate a signal indicative of the pressure of the drive fluid (DF),
(ii) a position sensor adapted to sense axial position of the second piston or the valve pin and generate a signal indicative of axial position of the second piston or the valve pin,
(iii) a position sensor adapted to sense one or more of axial position of a piston, rotational position and velocity of a rotor of the electrically powered actuator and generate a signal indicative of one or the other or both of rotational position and velocity of the rotor,
(iv) a sensor adapted to sense one or the other or both torque exerted by or current used by the electrically powered actuator and generate a signal indicative of one or the other or both of torque and current,
the controller including an algorithm that utilizes one or more signals generated by the pressure sensor, the position sensor or the torque or current sensor as a variable to controllably drive the second piston and the valve pin:
(a) to one or more predetermined axial positions during the course of an injection cycle, or,
(b) at one or more upstream or downstream velocities during the course of an injection cycle, or,
(c) to follow or match a preselected profile of pin positions or pin velocities during the course of an injection cycle, or,
(d) to open or close the gate or to trigger a movement or change in movement at a selected sensed pressure,
(e) to trigger an alarm indicative of degree of deviation in pressure of the drive fluid (DF) from one or more preselected desired pressures,
(f) upstream beginning from the gate closed position to a selected second intermediate upstream position at a first velocity, upstream from the second intermediate upstream position to a fully gate open position at one or more second velocities that are higher than the first velocity.

10. The apparatus of claim 1 further comprising a signal converter for converting signals generated by an injection molding machine (IMM) having a drivably rotatable barrel screw (BS) that generates an injection fluid, wherein the injection molding machine (IMM) includes a machine controller (MC) or a control unit (HPU) that generates one or more directional control valve compatible signals (VPS), wherein the direction control valve compatible signals (VPS) are compatible for use by a signal receptor, interface or driver of a standard fluid directional control valve to instruct the fluid directional control valve to move to a position that routes a source of drive fluid to flow in a direction that drives an interconnected fluid drivable actuator to move in a direction that operates to begin an injection cycle and to move in a direction that operates to end an injection cycle,
wherein the signal converter is interconnected to the machine controller (MC) or control unit (HPU), the signal converter receiving and converting the directional control valve compatible signals (VPS) to a command signal (MOPCS, PDCVS) that is compatible with a signal receptor or interface of an electrically powered actuator or a signal receptor or interface of a proportional directional control valve (V, V1, V2) that drives a fluid driven actuator,
wherein the signal converter includes a processor that converts the command signals (MOPCS, PDCVS) into a form, frequency, power or format that is usable by the signal receptor or interface of the electrically powered actuator or by the signal receptor or interface of the proportional directional control valve (V, V1, V2) to respectively cause the electrically powered actuator or the proportional directional control valve (V, V1, V2) to be driven in a direction that operates to either begin an injection cycle or to end an injection cycle.

11. An injection molding method, comprising:
providing a valve pin that is disposed in a flow channel, the flow channel adapted to pass injection fluid though a gate and into a mold cavity;
providing a first fluid drive cylinder having a first piston that is interconnected to a second fluid drive cylinder having a second piston in an arrangement wherein reciprocating movement of the first piston drives concomitant back and forth movement of the second piston,
interconnecting the valve pin to the second piston in an arrangement wherein reciprocating movement of the second piston drives concomitant back and forth movement of the valve pin through the flow channel between gate open and gate closed positions,
providing an electrically powered actuator that is interconnected to the first piston;
injecting a flow of the injection fluid to a heated manifold;
distributing the injection fluid, via the heated manifold, to the flow channel;
driving the first piston reciprocally within the first fluid drive cylinder via the electrically powered actuator according to a drive program that instructs the valve pin to be driven between the gate closed and gate open positions and one or more selected positions therebetween.

12. A method according to claim 11 further comprising using the electrically powered actuator as the sole source of drive force on the first piston.

13. A method according to claim 11 further comprising drivably interconnecting the first fluid drive cylinder and the second fluid drive cylinder in a closed fluid circuit arrangement.

14. A method according to claim 11 further comprising disposing the electrically powered actuator in a position remote from the heated manifold.

15. A method according to claim 11 further comprising sensing one or more of:
(i) pressure of drive fluid (DF) disposed within a fluid drive cylinder,
(ii) axial position of the second piston or the valve pin,
(iii) one or the other or both rotational position and velocity of a rotor of the electrically powered actuator,
(iv) one or the other or both torque exerted by or current used by the electrically powered actuator and generate a signal indicative of one or the other or both of torque and current, and,
using the sensed pressure, the sensed position, the sensed torque or current as a variable in an algorithm that controllably drives the second piston and the valve pin:
(a) to one or more predetermined axial positions during the course of an injection cycle, or,
(b) at one or more upstream or downstream velocities during the course of an injection cycle, or,
(c) to follow or match a preselected profile of pin positions or pin velocities during the course of an injection cycle, or,
(d) to open or close the gate or to trigger a movement or change in movement at a selected sensed pressure, or,
(e) to trigger an alarm indicative of degree of deviation in pressure of the drive fluid (DF) from one or more preselected desired pressures, or,
(f) upstream beginning from the gate closed position to a selected second intermediate upstream position at a first velocity, upstream from the second intermediate upstream position to a fully gate open position at one or more second velocities that are higher than the first velocity.

16. An injection molding system comprising:
an injection molding machine (IMM) that delivers an injection fluid to a heated manifold mounted between a top clamp plate and a mold having a cavity, the heated manifold adapted to distribute the injection fluid to a flow channel that is adapted to pass the injection fluid through a gate to the mold cavity;
a first fluid drive cylinder having a first piston disposed within the first fluid drive cylinder adapted to be driven reciprocally upstream and downstream within the first fluid drive cylinder;
a second fluid drive cylinder having a second piston disposed within the second fluid drive cylinder and interconnected to a valve pin
wherein the first fluid drive cylinder and the second fluid drive cylinder are interconnected in an arrangement wherein reciprocating movement of the first piston drives concomitant back and forth movement of the second piston and concomitant back and forth movement of the valve pin along a selected path of travel (Y) within the flow channel between gate closed and gate open positions;
an electrically powered actuator adapted to drive the first piston reciprocally within the first fluid drive cylinder according to a program that instructs the valve pin to be driven between the gate closed and gate open positions and one or more selected positions therebetween.

17. The system of claim 16 wherein the second actuator is mounted to one or the other or both of the heated manifold and the top clamp plate.

18. The system of claim 16 wherein the electrically powered actuator is the sole source of drive force on the first piston.

19. The system of claim 16 wherein the first fluid drive cylinder and the second fluid drive cylinder are drivably interconnected in a closed fluid circuit arrangement.

20. Apparatus of claim 1 wherein the electrically powered actuator is mounted in a position remote from the heated manifold.
